(19) United States
(12) Patent Application Publication
(10) Pub. No.: US 2011/0312272 A1
(43) Pub. Date: Dec. 22, 2011

(54) REMOTE CONTROL DEVICE, COMMUNICATION DEVICE, REMOTE CONTROL METHOD, AND PROGRAM

(75) Inventors: Tetsuro Goto, Kanagawa (JP); Masatoshi Ueno, Kanagawa (JP)

(73) Assignee: SONY CORPORATION, Tokyo (JP)

(21) Appl. No.: 13/203,258

(22) PCT Filed: Mar. 18, 2010
(86) PCT No.: PCT/JP2010/054666

§ 371 Date: Aug. 25, 2011

(30) Foreign Application Priority Data
Apr. 28, 2009 (JP) 2009-109517

(51) Int. Cl. H04B 5/00

(52) U.S. Cl. 455/41.1

(57) ABSTRACT

A remote control device including a near field radio communication unit capable of performing communication in accordance with a near field radio communication method, two or more control communication units each capable of performing communication in accordance with a communication method having a wider communication range than the near field radio communication method, a learning unit that receives learning data to be used for remotely controlling an apparatus to be controlled via the near field radio communication unit, and stores the received learning data into a storage medium, and a remote control unit that transmits a control signal for remotely controlling the apparatus to be controlled via one of the two or more control communication units on the basis of the learning data stored in the storage medium.

### TECHNICAL FIELD

The present invention relates to a remote control device, a communication device, a remote control method, and a program.

### BACKGROUND ART

Conventionally, remote controllers (remote control devices) for remotely controlling electronic apparatuses have been widely used. Remote controllers are divided into a dedicated type that can be used for electronic apparatuses of a single type or of a single manufacturer, and a shared type that can be used for electronic apparatuses of a plurality of types or of a plurality of manufacturers. As the shared remote controllers, the following types are known: a preset type in which control systems corresponding to a plurality of electronic apparatuses are stored in advance, a learning type in which a control system is learned from an electronic apparatus or from another remote controller and is then stored, a high-functionality type that has both the functions of the present type and the learning type, and the like.

As an example of the learning remote controllers that have been researched and developed so far, Patent Literature 1 below is given. Patent Literature 1 below proposes a method of storing in advance control systems corresponding to a plurality of types of electronic apparatuses into a storage means, which is provided separately from a remote controller, and then transferring a control system selected by a user as needed to the remote controller using a communication means such as infrared rays.

### CITATION LIST

### Patent Literature

Patent Literature 1: JP H7-135689A

### SUMMARY OF INVENTION

### Technical Problem

However, the conventional shared remote controllers have typically been provided in a form such that the shared remote controllers correspond only to a control communication means that is common to a plurality of electronic apparatuses and to a common operation. Examples of a control communication means that is common to a plurality of electronic apparatuses include IrDA (Infrared Data Association). Examples of a common operation include on/off of power, a volume change, and channel selection. A control communication means that can be used for the learning remote controller described in Patent Literature 1 above has also been only a single type like IrDA, for example. Meanwhile, as for the preset remote controllers, it is required, for example, that control systems of many electronic apparatuses released in the past be stored in advance and the operations thereof be checked. Thus, there has been a trade-off between the versatility of remote controllers and the workload of manufacturers, which has been a factor to limit the control communication means and the types of the controllable operations.

Meanwhile, in recent years, electronic apparatuses have come to be provided with various types of communication means such as, not only IrDA, but a wireless LAN (Local Area Network), Bluetooth®, or Zigbee. Thus, it would be advantageous if shared remote controllers can easily and selectively use a control communication means in accordance with a communication means of an electronic apparatus, without the types of the control communication means being limited.

Accordingly, the present invention provides a remote control device, a communication device, a remote control method, and a program, which are novel and improved, and which can selectively use a control communication means through simple learning in accordance with a communication means of an electronic apparatus.

### Solution to Problem

According to an embodiment of the present invention, there is provided a remote control device including a near field radio communication unit capable of performing communication in accordance with a near field radio communication method, two or more control communication units each capable of performing communication in accordance with a communication method having a wider communication range than the near field radio communication method, a learning unit that receives learning data to be used for remotely controlling an apparatus to be controlled via the near field radio communication unit, and stores the received learning data into a storage medium, and a remote control unit that transmits a control signal for remotely controlling the apparatus to be controlled via one of the two or more control communication units on the basis of the learning data stored in the storage medium.

According to such a configuration, the remote control devices receives learning data, which is to be used for remotely controlling the apparatus to be controlled, from the apparatus to be controlled via the near field radio communication unit, and then remotely controls the apparatus to be controlled via one of the control communication units on the basis of the received learning data. Accordingly, user is able to cause the remote control device to learn a control system of the apparatus to be controlled only through a simple operation of touching the apparatus to be controlled with the remote control device, and to perform remote control while selectively using a control communication means in accordance with the apparatus to be controlled.

The learning data may include data that identifies one or more communication methods that can be used by the apparatus to be controlled.

The remote control unit may, when two or more communication methods are identified from the learning data, select a communication method to be used for transmission of the control signal from among the two or more communication methods in accordance with a predetermined selection condition.

The predetermined selection condition may be a condition associated with at least one of a communication rate, power consumption, security, and a noise level.

The remote control device may further include a user input unit that allows a user to, when two or more pieces of the learning data are stored in the storage medium, select one of the two or more pieces of the learning data, and the remote control unit may transmit the control signal via a control communication unit corresponding to the learning data selected by the user via the user input unit.

The learning unit may, after receiving the learning data via the near field radio communication unit, attempt communication with the apparatus to be controlled via one of the two or more control communication units on the basis of the learning data.

The remote control device according may further include an annunciator unit that announces to a user a result of the attempt of the learning unit to communicate with the apparatus to be controlled.

According to another embodiment of the present invention, there is provided a communication device including a near field radio communication unit capable of performing communication in accordance with a near field radio communication method, a storage unit in which learning data to be used for remotely controlling the communication device is stored using a storage medium accessible from the near field radio communication unit, and a control communication unit capable of receiving a control signal for receiving remote control from a remote control device in accordance with a communication method having a wider communication range than the near field radio communication method. The learning data includes data that identifies at least a communication method that can be used by the control communication unit.

The communication device may further include an external communication unit capable of communicating with another communication device, and a control unit that receives new firmware to be used for remotely controlling the communication device via the external communication unit, and stores new learning data corresponding to the received firmware into the storage unit.

The communication device may further include a control unit that, when a data size of the learning data exceeds a storage capacity of the storage unit, splits the learning data into a plurality of pieces of data and sequentially stores each split data into the storage unit.

The communication device may further include a control unit that stores one of a plurality of pieces of leaning data that can be used for remotely controlling the communication device into the storage unit in accordance with an identifier of a remote control device written to the storage unit.

The near field radio communication unit may be a reader/writer capable of behaving as a near field radio communication tag in accordance with the near field radio communication method.

According to still another embodiment of the present invention, there is provided a remote control method using a remote control device, the remote control device including a near field radio communication unit capable of performing communication in accordance with a near field radio communication method, and two or more control communication units each capable of performing communication in accordance with a communication method having a wider communication range than the near field radio communication method, the method including the steps of receiving learning data to be used for remotely controlling an apparatus to be controlled from the apparatus to be controlled via the near field radio communication unit, storing the received learning data into a storage medium, and transmitting a control signal for remotely controlling the apparatus to be controlled via one of the two or more control communication units on the basis of the learning data stored in the storage medium.

According to yet another embodiment of the present invention, there is provided a program for causing a computer that controls a remote control device including a near field radio communication unit capable of performing communication in accordance with a near field radio communication method, and two or more control communication units each capable of performing communication in accordance with a communication method having a wider communication range than the near field radio communication method, to function as a learning unit that receives learning data to be used for remotely controlling an apparatus to be controlled via the near field radio communication unit, and stores the received learning data into a storage medium, and a remote control unit that transmits a control signal for remotely controlling the apparatus to be controlled via one of the two or more control communication units on the basis of the learning data stored in the storage medium.

### Advantageous Effects of Invention

As described above, according to the remote control device, the communication device, the remote control method, and the program in accordance with the present invention, it is possible to selectively use a control communication means through simple learning in accordance with a communication means of an electronic apparatus.

### BRIEF DESCRIPTION OF DRAWINGS

FIG. 1 is a block diagram showing an exemplary physical configuration of a remote control device in accordance with the first embodiment.

FIG. 2 is a block diagram showing an exemplary logical functional arrangement of the remote control device in accordance with the first embodiment.

FIG. 3 is a block diagram showing an exemplary physical configuration of the apparatus to be controlled in accordance with the first embodiment.

FIG. 4 is a block diagram showing an exemplary logical functional arrangement of the apparatus to be controlled in accordance with the first embodiment.

FIG. 5 is a flowchart showing an exemplary flow of a learning process of the remote control device in accordance with the first embodiment.

FIG. 6 is a flowchart showing an exemplary flow of a response process of the apparatus to be controlled in accordance with the learning process shown in FIG. 5.

FIG. 7 is an explanatory diagram exemplarily showing a view in which a user starts remote control.

FIG. 8 is an explanatory diagram exemplarily showing a view in which the result of an attempt of control communication is announced.

FIG. 9 is an explanatory diagram exemplarily showing a view in which the status of a learning process is announced.

FIG. 10A is the first half of an explanatory diagram exemplarily showing a view in which a plurality of pieces of leaning data is stored in a remote control device.

FIG. 10B is the second half of an explanatory diagram exemplarily showing a view in which a plurality of pieces of leaning data is stored in a remote control device.

FIG. 11 is an explanatory diagram exemplarily showing a view in which learning data selected from among a plurality of pieces of leaning data is used for remote control.

FIG. 12 is an explanatory diagram for illustrating a case in which the apparatus to be controlled can perform control communication using a plurality of communication methods.

FIG. 13 is a block diagram showing an exemplary logical functional arrangement of a remote control device in accordance with the second embodiment.

FIG. 14 is a block diagram showing an exemplary physical configuration of the apparatus to be controlled in accordance with the second embodiment.

FIG. 15 is a block diagram showing an exemplary logical functional arrangement of the apparatus to be controlled in accordance with the second embodiment.

FIG. 16 is a flowchart showing an exemplary flow of a learning process of the remote control device in accordance the second embodiment.

FIG. 17 is a flowchart showing an exemplary flow of a response process of the apparatus to be controlled in accordance with the learning process shown in FIG. 16.

FIG. 18A is the first half of an explanatory diagram showing a view in which a learned control system is updated.

FIG. 18B is the second half of an explanatory diagram showing a view in which a learned control system is updated.

FIG. 19A is the first half of an explanatory diagram showing a view in which learning data is selected in accordance with the device identifier of a remote control device.

FIG. 19B is the second half of an explanatory diagram showing a view in which learning data is selected in accordance with the device identifier of a remote control device.

FIG. 20 is an explanatory diagram showing a view in which the result of an attempt of control communication is announced by the apparatus to be controlled.

FIG. 21 is a block diagram showing an exemplary physical configuration of the apparatus to be controlled in accordance with one variation of the second embodiment.

FIG. 22 is a flowchart showing an exemplary flow of a learning process in accordance with one variation of the second embodiment.

FIG. 23 is a flowchart showing an exemplary flow of a response process of the apparatus to be controlled in accordance with the learning process shown in FIG. 22.

FIG. 24 is a block diagram showing an exemplary logical functional arrangement of a remote control device in accordance with the third embodiment.

FIG. 25 is a block diagram showing an exemplary logical functional arrangement of the apparatus to be controlled in accordance with the third embodiment.

FIG. 26 is an explanatory diagram exemplarily showing a view in which remote control in accordance with the third embodiment is started.

FIG. 27 is an explanatory diagram for illustrating a method of providing learning data to the apparatus to be controlled in accordance with one variation.

FIG. 28 is an explanatory diagram for illustrating another method of providing learning data to the apparatus to be controlled as one variation.

### DESCRIPTION OF EMBODIMENTS

Hereinafter, preferred embodiments of the present invention will be described in detail with reference to the appended drawings. Note that, in this specification and the drawings, elements that have substantially the same function and structure are denoted with the same reference signs, and repeated explanation is omitted.

The “Description of Embodiments” will be described in accordance with the following order.

1. First Embodiment
1-1. Exemplary Configuration of Remote Control Device
1-2. Exemplary Configuration of Apparatus to be Controlled
1-3. Process Flow
1-4. Examples of Use Scenes

2. Second Embodiment
2-1. Exemplary Configuration of Remote Control Device
2-2. Exemplary Configuration of Apparatus to be Controlled
2-3. Process Flow
2-4. Examples of Use Scenes
2-5. Another Exemplary Configuration of Apparatus to be Controlled
2-6. Another Form of Communication between Remote Control Device and Apparatus to be Controlled

3. Third Embodiment
3-1. Exemplary Configuration of Remote Control Device
3-2. Exemplary Configuration of Apparatus to be Controlled
3-3. Examples of Use Scenes

4. Variation

5. Conclusion

### 1. First Embodiment

[1-1. Exemplary Configuration of Remote Control Device]

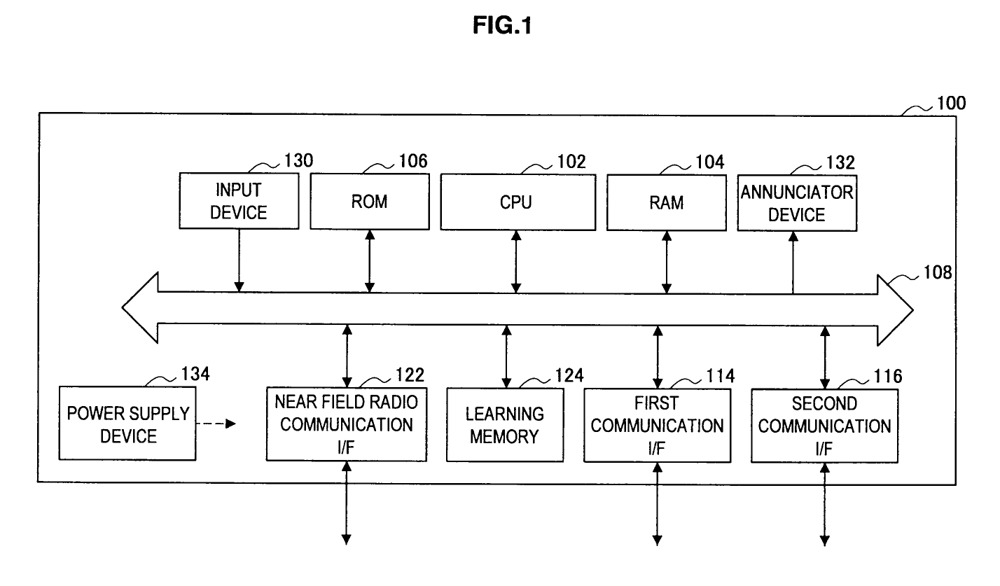

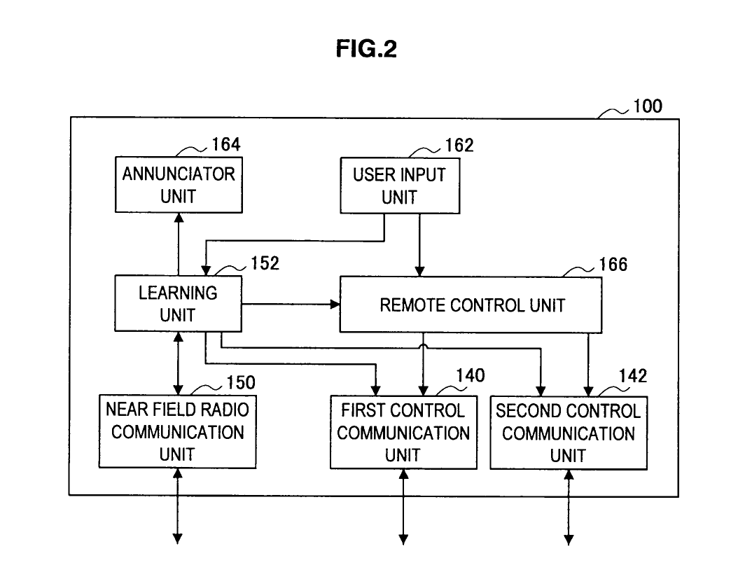

First, an exemplary configuration of a remote control device 100 in accordance with the first embodiment of the present invention will be described with reference to FIG. 1 and FIG. 2. Note that in this embodiment, the remote control device 100 can be a remote controller having only a function for remotely controlling an electronic apparatus or a device having additional functions. That is, the remote control device 100 can be, for example, a portable phone terminal, a portable information terminal, a portable game terminal, or a game controller.

(Physical Configuration)

FIG. 1 is a block diagram showing an exemplary physical configuration of the remote control device 100 in accordance with this embodiment. Referring to FIG. 1, the remote control device 100 includes a CPU (Central Processing Unit) 102, RAM (Random Access Memory) 104, ROM (Read Only Memory) 106, a bus 108, a first communication interface (hereinafter referred to as an I/F) 114, a second communication I/F 116, a near field radio communication I/F 122, learning memory 124, an input device 130, an annunciator device 132, and a power supply device 134.

The CPU 102 is an arithmetic unit used to control the entire functions of the remote control device 100. The CPU 102, for example, reads a control program (firmware) stored in the ROM 106 and controls each unit of the remote control device 100 in accordance with the program. In the RAM 104, a program or data used by the CPU 102 is temporarily stored while the CPU 102 is operating. In the ROM 106, the aforementioned control program or predetermined program data is stored in advance.

The bus 108 mutually connects the CPU 102, the RAM 104, the ROM 106, the first communication I/F 114, the second communication I/F 116, the near field radio communication I/F 122, the learning memory 124, the input device 130, and the annunciator device 132.

Each of the first communication I/F 114 and the second communication I/F 116 is an interface that mediates communication between the remote control device 100 and another communication device in accordance with a given communication method. The communication method supported by each of the first communication I/F 114 and the second communication I/F 116 can be, for example, an optical communication method such as IrDA or laser communication, or a radio communication method that can include a wireless LAN, Bluetooth®, or Zigbee®. Meanwhile, when the remote control device 100 is a portable phone terminal, for example, the first communication I/F 114 or the second communication I/F 116 can be an interface for portable phones that supports PDC, GSM, W-CDMA, or the like. In any case, the communication method supported by each of the first communication I/F 114 and the second communication I/F 116 typically has a wider communication range than a near field radio communication method that is supported by the near field radio communication I/F 122 described below.

The near field radio communication I/F 122 is an interface that operates as a reader/writer capable of receiving data from and outputting data to an RF (Radio Frequency) tag in accordance with a near field radio communication method. The near field radio communication method supported by the near field radio communication I/F 122 can be, for example, NFC (Near Field Communication), or Felica® or Mifare® that is downward compatible with the NFC. The learning memory 124 is a storage medium accessible from the near field radio communication I/F 122, and can be constructed as semiconductor memory such as flash memory, for example.

The input device 130 includes a user interface that can be operated by a user, such as a button, a switch, a dial, or a touch panel, for example. The input device 130 generates an operation signal upon detecting an operation of the user, and outputs the generated operation signal to the CPU 102. The annunciator device 132 is a device used for the remote control device 100 to inform the user of given information. The annunciator device 132 can be, for example, a display device with a predetermined screen, a light-emitting device such as a lamp, an audio output device such as a speaker, or a vibrator. The power supply device 134 is a device for supplying power to each of the aforementioned units of the remote control device 100.

(Logical Configuration)

FIG. 2 is a block diagram showing an exemplary logical functional arrangement of the remote control device 100 that is implemented using the physical configuration shown in FIG. 1. Referring to FIG. 2, the remote control device 100 includes a first control communication unit 140, a second control communication unit 142, a near field radio communication unit 150, a learning unit 152, a user input unit 162, an annunciator unit 164, and a remote control unit 166.

The first control communication unit 140 communicates with another communication device using the first communication I/F 114 shown in FIG. 1 in accordance with control from the remote control unit 166 described below. For example, when the first communication I/F 114 supports a wireless LAN such as IEEE 802.11a, b, g, or n, the first control communication unit 140 generates an IP packet including a control signal output from the remote control unit 166, and transmits the IP packet from the first communication I/F 114. Likewise, the second control communication unit 142 communicates with another communication device using the second communication I/F 116 shown in FIG. 1 in accordance with control from the remote control unit 166 described below.

The near field radio communication unit 150 reads data from or writes data to a nearby RF tag using the near field radio communication I/F 122 shown in FIG. 1 in accordance with control from the learning unit 152 described below. More specifically, the near field radio communication unit 150, upon receiving from the learning unit 152 an instruction signal instructing a start of learning a control system of an electronic apparatus, outputs a connection request and a request for transmission of learning data to a nearby RF tag via an antenna of the near field radio communication I/F 122. Consequently, the near field radio communication unit 150 receives learning data from the nearby RF tag and outputs the received learning data to the learning unit 152.

The learning unit 152 controls a process of learning a control system of an electronic apparatus (e.g., a communication device 200 described below) to be remotely controlled, using the CPU 102 shown in FIG. 1. More specifically, the learning unit 152, upon receiving an operation signal of a predetermined type from the user input unit 162, instructs the near field radio communication unit 150 to receive learning data to be used for remotely controlling the apparatus to be controlled. Then, the learning unit 152 stores the learning data received via the near field radio communication unit 150 into the learning memory 124 shown in FIG. 1. The learning data typically includes data (e.g., an identifier of a communication protocol) identifying a communication method that can be used by the apparatus to be controlled. Such learning data is used to select an adequate communication method to be used in remotely controlling the apparatus to be controlled. In addition, the learning data can include assignment data that defines the assignment of a control command for the apparatus to be controlled, such as on/off of power, a volume change, or channel selection, to a user interface (UI) of the input device 130. Further, the learning data can include communication profile data (e.g., data identifying the type, wavelength, frequency, or the like of the signal waveform of IrDA) that is necessary to establish control communication with the apparatus to be controlled. Furthermore, the learning data can include firmware that can be executed by the remote control unit 166, namely, a control program itself.

Further, in this embodiment, the learning unit 152, upon receiving learning data via the near field radio communication unit 150, attempts communication between either of the first control communication unit 140 or the second control communication unit 142 identified on the basis of the learning data and the apparatus to be controlled. Then, the learning unit 152 announces to the user if the communication has succeeded or not using the annunciator unit 164. In addition, the learning unit 152 can announce to the user, in addition to if the communication has succeeded or not, a processing status from the start of the learning process to the success (or failure) of the attempt of communication, using the annunciator unit 164.

The user input unit 162 outputs an operation signal in accordance with an operation of the user, which is generated by the input device 130 described in relation to FIG. 1, to the learning unit 152 or the remote control unit 166. For example, the user input unit 162, when a specific button of the input device 130 has been pressed, outputs to the learning unit 152 an operation signal for triggering the start of the aforementioned control system learning process. In addition, for example, the user input unit 162, when another button of the input device 130 has been pressed, outputs to the remote control unit 166 an operation signal for performing remote control corresponding to the type of the button. Further, the user input unit 162 can output to the learning unit 152 or the remote control unit 166 an operation signal for switching a control system for remote control or the like as described below.

The annunciator unit 164 announces to the user if the attempt of control communication has succeeded or not, the processing status of the learning process, or the like, using the annunciator device 132 shown in FIG. 1 in accordance with control from the learning unit 152. For example, when the annunciator device 132 includes a display device, the annunciator unit 164 can display information to be announced on a screen of the display device using text or an image. Alternatively, when the annunciator device 132 includes an audio output device, for example, the annunciator unit 164 can cause the audio output device to output a success sound if the attempt of control communication has succeeded and to output a warning sound if the attempt of control communication has failed.

The remote control unit 166 remotely controls the apparatus to be controlled using the CPU 102 shown in FIG. 1. In this case, the remote control unit 166 selects either of the first control communication unit 140 or the second control communication unit 142 on the basis of the aforementioned learning data stored in the learning memory 124 by the learning unit 152. Then, the remote control unit 166 transmits a control signal to the apparatus to be controlled via the selected control communication unit. More specifically, upon input of an operation signal in accordance with an operation of the user from the user input unit 162, the remote control unit 166 generates a control signal corresponding to the input operation signal in accordance with the control system identified from the aforementioned learning data. For example, the remote control unit 166, upon receiving an operation signal indicating that a button for powering on the apparatus to be controlled has been pressed, generates a control signal indicating that the apparatus to be controlled should be powered on. Next, the remote control unit 166 acquires data (e.g., an identifier of a communication method) identifying a communication method that can be used by the apparatus to be controlled from the aforementioned learning data, and selects a control communication unit corresponding to the communication method (the first control communication unit 140 or the second control communication unit 142). Then, the remote control unit 166 transmits the generated control signal to the apparatus to be controlled via the selected control communication unit.

Heretofore, an exemplary configuration of the remote control device 100 in accordance with this embodiment has been described with reference to FIG. 1 and FIG. 2. Although description has been made of an example in which the remote control device 100 has two control communication units, namely, the first control communication unit 140 and the second control communication unit 142, the remote control device 100 can have three or more control communication units.

[1-2. Exemplary Configuration of Apparatus to be Controlled]

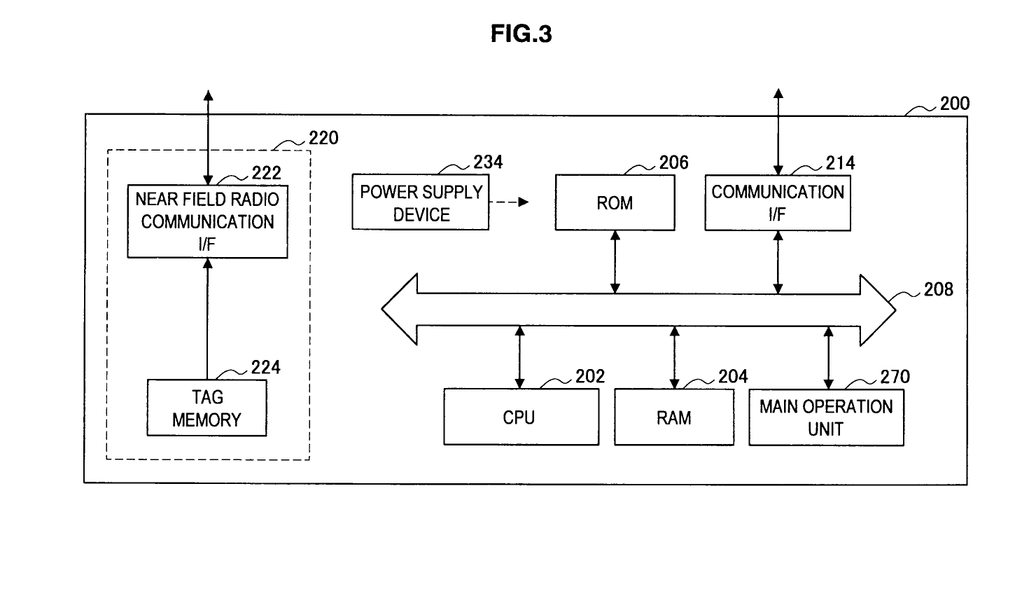

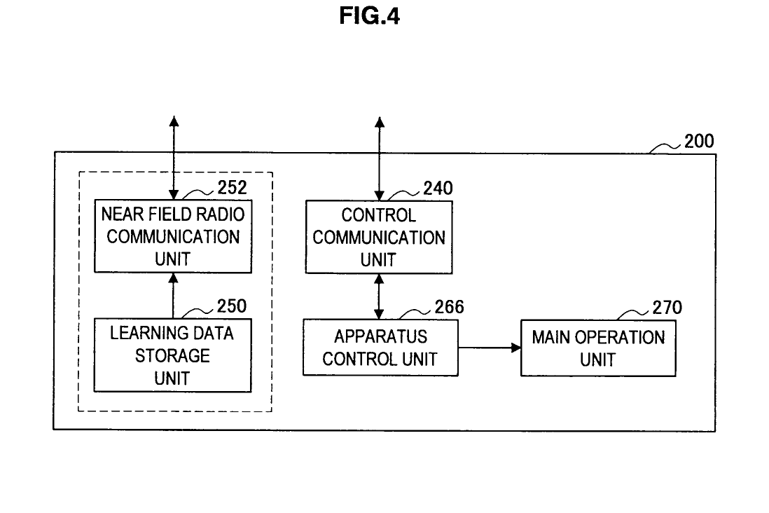

Next, an exemplary configuration of the communication device 200 as an example of the apparatus to be controlled in accordance with this embodiment will be described with reference to FIG. 3 and FIG. 4. Note that in this embodiment, the communication device 200 can be an information processing device or the like that has a communication function based on a given communication method and that can be remotely controlled in accordance with a given control system, such as a household electrical apparatus, a game machine, or a PC (Personal Computer).

(Physical Configuration)

FIG. 3 is a block diagram showing an exemplary physical configuration of the communication device 200. Referring to FIG. 3, the communication device 200 includes a CPU 202, RAM 204, ROM 206, a bus 208, a communication I/F 214, a near field radio communication tag 220, a power supply device 234, and a main operation unit 270.

The CPU 202 is an arithmetic unit used to control the entire functions of the communication device 200. The CPU 202 reads, for example, a control program stored in the ROM 206, and controls each unit of the communication device 200 in accordance with the program. In the RAM 204, a program or data used by the CPU 202 is temporarily stored while the CPU 202 is operating. In the ROM 206, the aforementioned control program or predetermined program data is stored in advance.

The bus 208 mutually connects the CPU 202, the RAM 204, the ROM 206, the communication I/F 214, and the main operation unit 270.

The communication I/F 214 is an interface that mediates communication between the communication device 200 and the remote control device 100 or another communication device in accordance with a given communication method. The communication method supported by the communication I/F 214 can be any of the communication methods listed in relation to the first communication I/F 114 and the second communication I/F 1216 of the remote control device 100.

The near field radio communication tag 220 is an RF tag including a near field radio communication I/F 222 and tag memory 224. The near field radio communication I/F 222 receives data from and outputs data to the tag memory 224 in response to predetermined commands transmitted from a reader/writer in accordance with any of the aforementioned near field radio communication methods. The tag memory 224 is a storage medium accessible from the near field radio communication I/F 222, and can be constructed as semiconductor memory such as flash memory, for example. Note that such a near field radio communication tag 220 can be provided integrally with the chassis of the communication device 200 or provided such that it is attached to the surface of the chassis of the communication device 200.

The main operation unit 270 is a portion that implements the main function provided to the user in accordance with the purpose of the communication device 200. For example, when the communication device 200 is a receiver of a digital television broadcast, the main operation unit 270 has functions of receiving a digital television broadcast and displaying a television program on the screen. Alternatively, for example, when the communication device 200 is a music player, the main operation unit 270 has functions of acquiring music data from a predetermined medium and playing the music data.

The power supply device 234 is a device for supplying power to each of the aforementioned units of the communication device 200. Note that when the near field radio communication tag 220 is a passive tag capable of obtaining operation power from electromagnetic waves from a reader/writer, the power supply device 234 need not supply power to the near field radio communication tag 220.

(Logical Configuration)

FIG. 4 is a block diagram showing an exemplary logical functional arrangement of the communication device 200 that is implemented using the physical configuration shown in FIG. 3. Referring to FIG. 4, the communication device 200 includes a control communication unit 240, a learning data storage unit 250, a near field radio communication unit 252, an apparatus control unit 266, and a main operation unit 270.

The control communication unit 240 receives a control signal transmitted from the remote control device 100, using the communication I/F 214 shown in FIG. 3, for example. Then, the control communication unit 240 outputs the received control signal to the apparatus control unit 266.

In the learning data storage unit 250, learning data to be used for the remote control device 100 to remotely control the communication device 200 is stored in advance, using the tag memory 224 shown in FIG. 3. The learning data can include, for example, data identifying a communication method described in relation to the learning unit 152 of the remote control device 100, assignment data, communication profile data, firmware that can be executed by the remote control unit 166 of the remote control device 100, or the like. Such learning data is read from the learning data storage unit 250 by the near field radio communication unit 252 in response to a request for transmission of learning data output from the near field radio communication unit 150 of the remote control device 100.

The near field radio communication unit 252 receives a signal output from a reader/writer in accordance with a near field radio communication method, using the near field radio communication I/F 222 shown in FIG. 3. More specifically, for example, the near field radio communication unit 252 receives a request for transmission of learning data output from the near field radio communication I/F 122 of the remote control device 100. Then, the near field radio communication unit 252 reads the aforementioned learning data from the learning data storage unit 250 in response to the received transmission request, and transmits the read learning data to the remote control device 100. Accordingly, the remote control device 100 can learn a control system for remotely controlling the communication device 200.

The apparatus control unit 266 controls the function of the main operation unit 270 of the communication device 200, using the CPU 202 shown in FIG. 3. For example, the apparatus control unit 266, upon receiving from the control communication unit 240 a control signal, which is a control signal received from the remote control device 100 and which corresponds to a specific operation of the main operation unit 270, instructs the main operation unit 270 to perform the operation. Accordingly, remote control of the communication device 200 using the remote control device 100 is realized. For example, when the communication device 200 is a digital television receiver, the user is able to remotely control on/off of power, a volume change, channel selection, or the like of the receiver using the remote control device 100.

Heretofore, an exemplary configuration of the communication device 200 as an example of the apparatus to be controlled in accordance with this embodiment has been described with reference to FIG. 3 and FIG. 4. Although description has been made of an example in which the communication device 200 has a single control communication unit 240, the communication device 200 can have two or more control communication units.

[1-3. Process Flow]

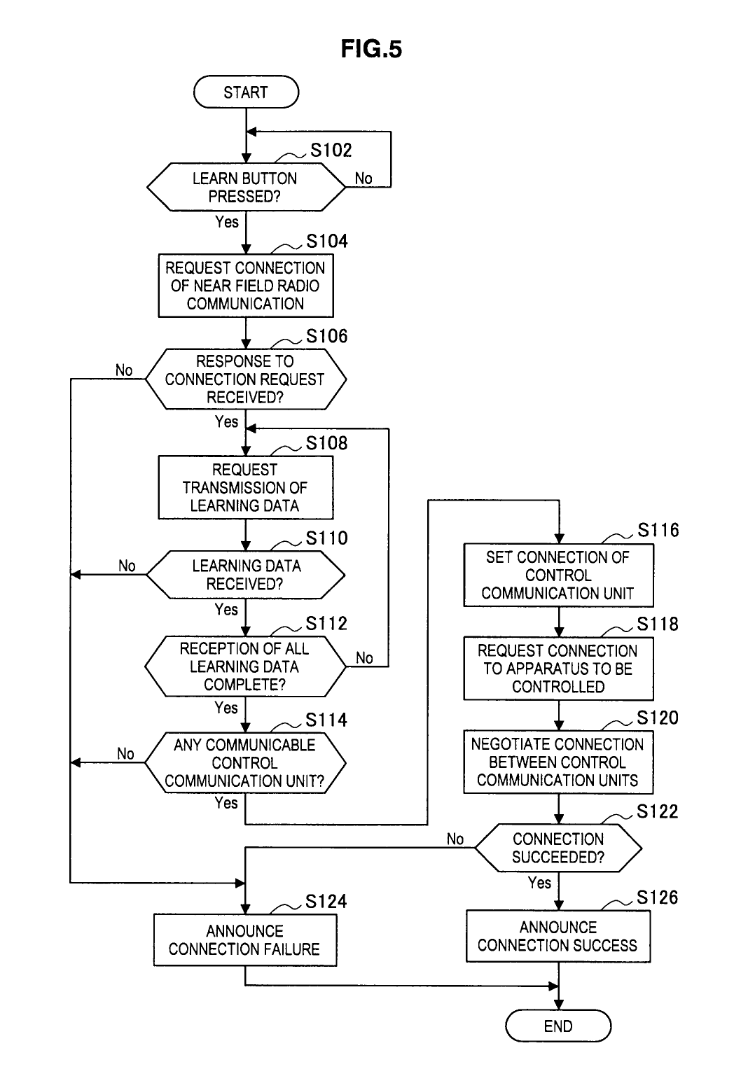

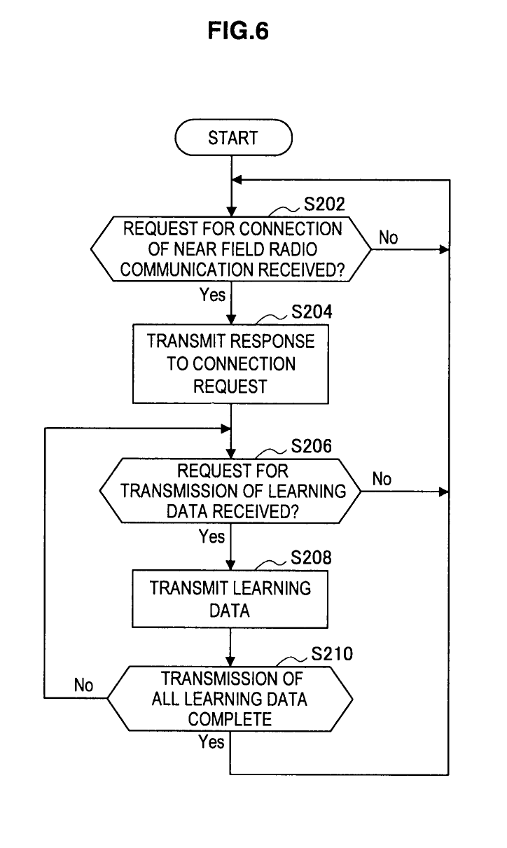

Next, a flow of a learning process up to the establishment of control communication between the aforementioned remote control device 100 and communication device 200 will be described with reference to FIG. 5 and FIG. 6. FIG. 5 is a flowchart showing an exemplary flow of a learning process of the remote control device 100 up to the establishment of control communication with the communication device 200.

Referring to FIG. 5, first, the user input unit 162 of the remote control device 100 determines if a learn button has been pressed (S102). The learn button can be, for example, a button as hardware provided on the surface of the chassis of the remote control device 100, or a button as software displayed on the screen of the remote control device 100. Instead of the button, a switch or the like can also be used. Herein, if the learn button is determined to have been pressed, the process proceeds to step S104.

In step S104, the learning unit 152 transmits a request for connection of near field radio communication to a nearby apparatus to be controlled via the near field radio communication unit 150 (S104). Thereafter, the learning unit 152 waists for a response to the request for connection of near field radio communication (S106). Herein, if no response is received after a given time has elapsed, the connection fails upon time-out, and the process proceeds to step S124. Meanwhile, if a response to the request for connection of near field radio communication is received, the process proceeds to step S108.

In step S108, the learning unit 152 transmits a request for transmission of learning data to the communication device 200, which is the apparatus to be controlled having responded to the connection request, via the near field radio communication unit 150 (S108). Thereafter, the learning unit 152 waits for the reception of learning data from the communication device 200 (S110). Herein, if learning data is not received after a given time has elapsed, the learning fails upon time-out, and the process proceeds to step S124. Meanwhile, if learning data from the communication device 200 is received, the process proceeds to step S112.

In step S112, the learning unit 152 further determines if reception of all learning data is complete (S112). For example, the learning unit 152 compares the size of the learning data, which is described in the initially received data, with the size of the learning data that has been received, and can, if the sizes of both the data are equal, determine that reception of all learning data is complete. Herein, if reception of all learning data is complete, the process proceeds to step S114. Meanwhile, if reception of all learning data is not complete yet, the process returns to step S108, so that transmission and reception of the remaining learning data are repeated.

In step S114, the learning unit 152 determines, on the basis of the received learning data, if there is any control communication unit that can communicate with the communication device 200 among the control communication units of the remote control device 100 (S114). For example, the learning unit 152 can, if the remote control device 100 has a control communication unit that supports a communication method corresponding to the identifier included in the received learning data, determine the presence of a control communication unit that can communicate with the communication device 200. Herein, if there is no control communication unit that can communicate with the communication device 200, the connection fails due to the mismatched functions, and the process proceeds to step S124. Meanwhile, there is a control communication unit that can communicate with the communication device 200, the process proceeds to step S116.

Step S116 to step S120 are the steps making up the process performed by the learning unit 152 to attempt connection to the communication device 200.

First, in step S116, the learning unit 152, on the basis of the learning data received from the communication device 200, performs connection settings of the control communication unit to be used for remote control (S116). For example, when remotely controlling the communication device 200 using IrDA via the first control communication unit 140, the learning unit 152 sets the waveform and the like of a signal transmitted from the first control communication unit 140, using the communication profile data about IrDA included in the learning data.

Next, in step S118, the learning unit 152 requests a communication connection to the communication device 200, which is the apparatus to be controlled, via the set control communication unit (S118). Further, the learning unit 162 negotiates a connection with the communication device 200 as needed (S120). For example, when control communication is performed using a wireless LAN, Bluetooth®, or the like, a mutual authentication process or the like can be performed during the connection negotiation.

Thereafter, in step S122, the learning unit 152 determines if the connection of control communication has succeeded (S122). Herein, if the connection of control communication has failed, the process proceeds to step S124. Meanwhile, if the connection of control communication has succeeded, the process proceeds to S126.

In step S124, the annunciator unit 164 announces the failure of the connection of control communication to the user using the annunciator device 132 that can include a display device, an audio output device, a vibrator, or the like (S124). The annunciator unit 164 can perform announcement by, for example, varying the content of display on the display device, the content of sound, or a vibration pattern of the vibrator so that causes of the connection error can be distinguished.

Meanwhile, in step S126, the annunciator unit 164 announces the success of the connection of control communication to the user (S126). Then, it becomes possible for the user to remotely control the communication device 200 using the remote control device 100. Note that the learning data used for the connection of control communication at this time is stored in the learning memory 124 so that the learning data is used later for the remote control unit 166 to perform remote control.

FIG. 6 is a flowchart showing an exemplary flow of a response process performed by the near field radio communication unit 252 of the communication device 200 in accordance with the learning process described with reference to FIG. 5.

Referring to FIG. 6, first, the near field radio communication unit 252 of the communication device 200 waits for the reception of a request for connection of near field radio communication from the remote control device 100 (S202). Then, upon receiving a request for connection of near field radio communication, the near field radio communication unit 252 transmits a response to the connection request to the remote control device 100 (S204).

Next, the near field radio communication unit 252 waits for a request for transmission of learning data from the remote control device 100 (S206). Then, upon receiving a request for transmission of learning data, the near field radio communication unit 252 acquires learning data from the learning data storage unit 250, and transmits the learning data to the remote control device 100 (S208). Thereafter, if transmission of all learning data is not complete yet, the process returns to step S206, so that transmission and reception of the remaining learning data are repeated (S210). Meanwhile, if transmission of all learning data is complete, the process returns to step S202 to start waiting for the reception of a request for connection of near field radio communication again.

Through the aforementioned learning process, it becomes possible to perform remote control using a communication method that can be used by the communication device 200 among a plurality of communication methods supported by the remote control device 100.

[1-4. Examples of Use Scenes]

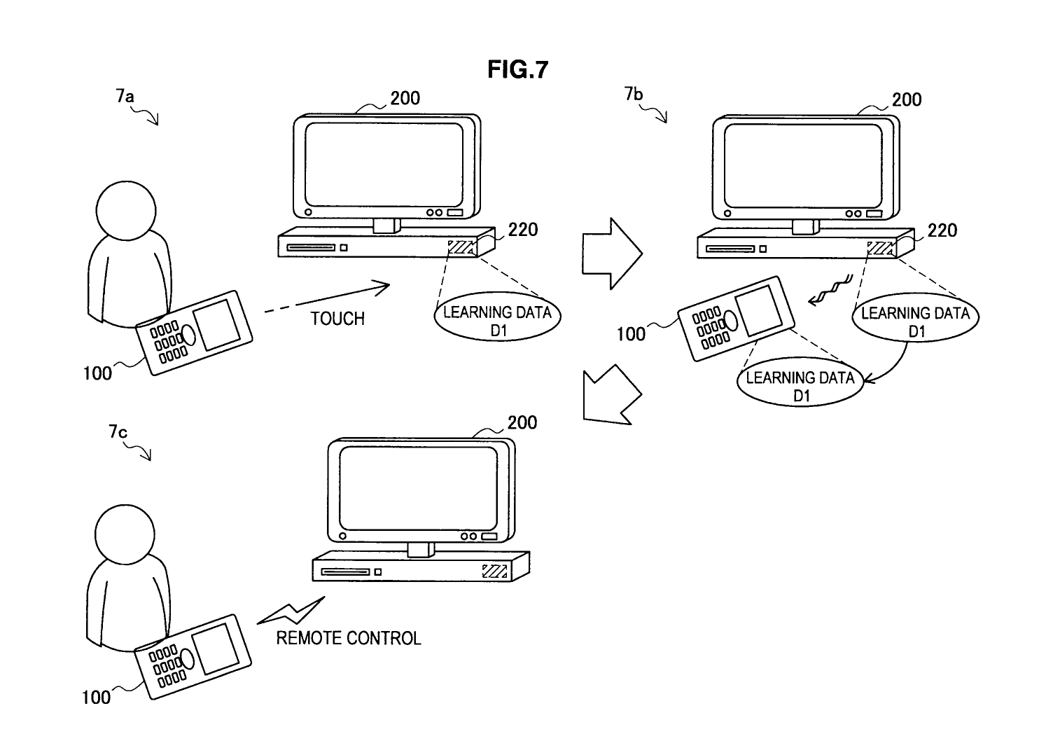

Next, scenes in which the aforementioned remote control method is used will be described with reference to FIG. 7 to FIG. 12.

FIG. 7 is an explanatory diagram showing a view in which a user starts remote control of the communication device 200 using the remote control device 100.

Referring to FIG. 7, a user, when starting remote control of the communication device 200, touches the near field radio communication tag 220 of the communication device 200 with the remote control device 100 while pressing a predetermined button (a learn button) of the remote control device 100, for example (see 7a). Then, learning data D1 that has been stored in advance in the radio communication tag 220 is transmitted from the near field radio communication tag 220 to the remote control device 100 (see 7b). The learning data D1 is then stored into the learning memory 124 of the remote control device 100. Thereafter, when an attempt of control communication between the remote control device 100 and the communication device 200 has succeeded, it becomes possible for the user to remotely control the communication device 200 using the remote control device 100 (see 7c).

That is, according to the configuration in accordance with this embodiment, as long as there exists a communication method for control communication that can be used in common for the physical layers between the remote control device 100 and the communication device 200, remote control of the communication device 200 using the remote control device 100 is realized through a simple “touch” operation. In addition, since the remote control device 100 need not know a control system for remotely controlling the communication device 200 in advance, it is possible to, even when the communication device 200 uses a unique control system, remotely control the communication device 200 by learning the control system.

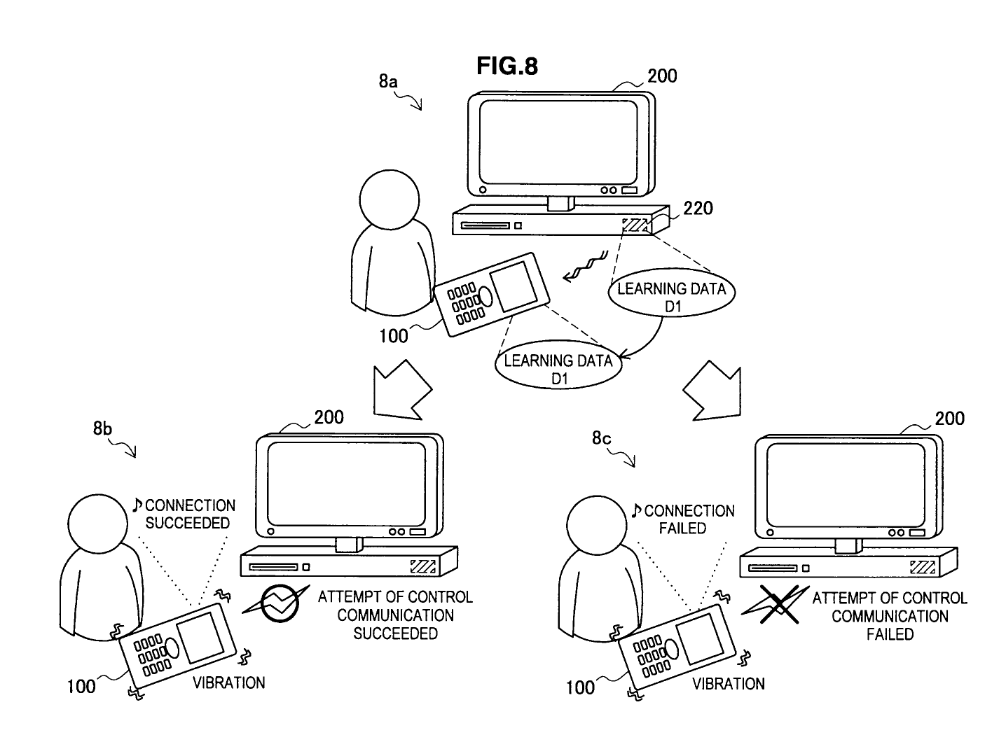

FIG. 8 is an explanatory diagram showing a view in which the result of an attempt of control communication between the remote control device 100 and the communication device 200 is announced by the remote control device 100.

Referring to FIG. 8, after the learning data D1 is transmitted from the near field radio communication tag 220 of the communication device 200 to the remote control device 100 (see 8a), connection of control communication is attempted between the remote control device 100 and the communication device 200. Then, if the connection of control communication between the remote control device 100 and the communication device 200 has succeeded, the success of the connection is announced to the user using a sound of the audio output device and a vibration of the vibrator included in the annunciator device 132 of the remote control device 100 (see 8b). Likewise, if the connection of control communication between the remote control device 100 and the communication device 200 has failed, the failure of the connection is announced to the user using a sound of the audio output device and a vibration of the vibrator described above (see 8c).

According to such a configuration, the user is able to easily know if remote control of the communication device 200 has become possible after he/she has touched the communication device 200 with the remote control device 100.

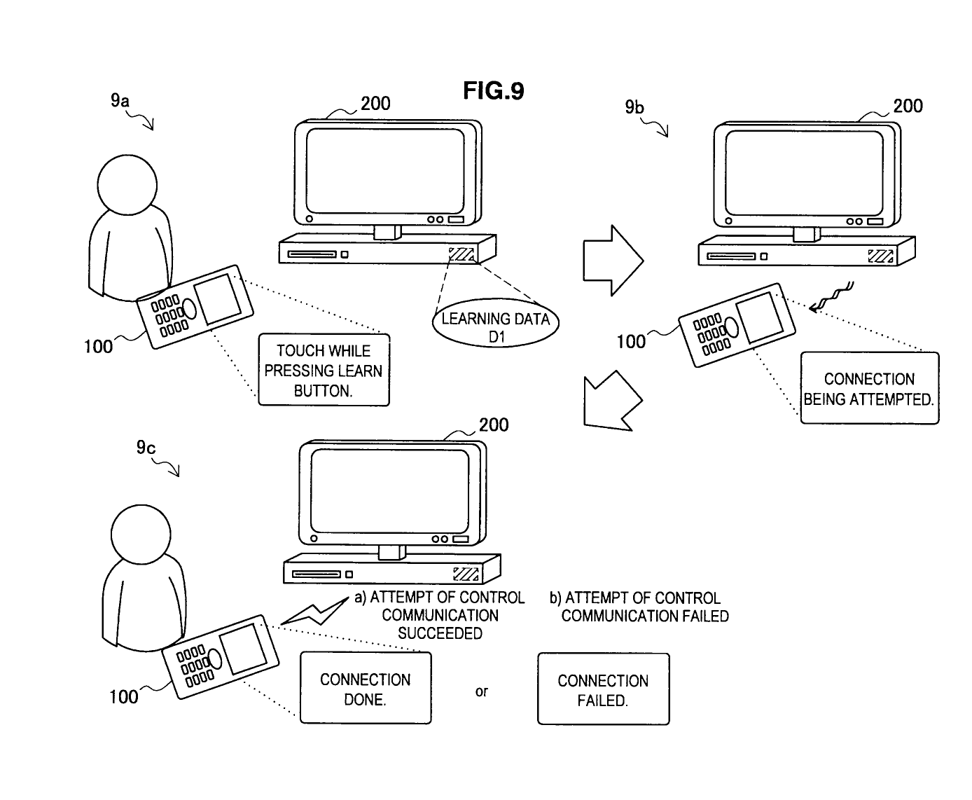

FIG. 9 is an explanatory diagram showing a view in which the status of a learning process between the remote control device 100 and the communication device 200 is announced.

Referring to FIG. 9, first, at the start of learning a control system, a message that prompts a user to touch is displayed on the screen of the remote control device 100 (FIG. 9a). Thereafter, while the user is touching and performing a control system learning process between the remote control device 100 and the communication device 200, a message indicating that the process is in progress (connection is being attempted) is displayed on the screen of the remote control device 100 (see 9b). Further, when the attempt of connection of control communication between the remote control device 100 and the communication device 200 has terminated, a message for announcing a success or failure of the attempt is displayed on the screen (see 9c).

In this manner, when the remote control device 100 has a display device, it is possible to sequentially announce to the user the status of a learning process between the remote control device 100 and the communication device 200 using a screen of the display device. Accordingly, the user is able to more easily learn a control system using the remote control device 100.

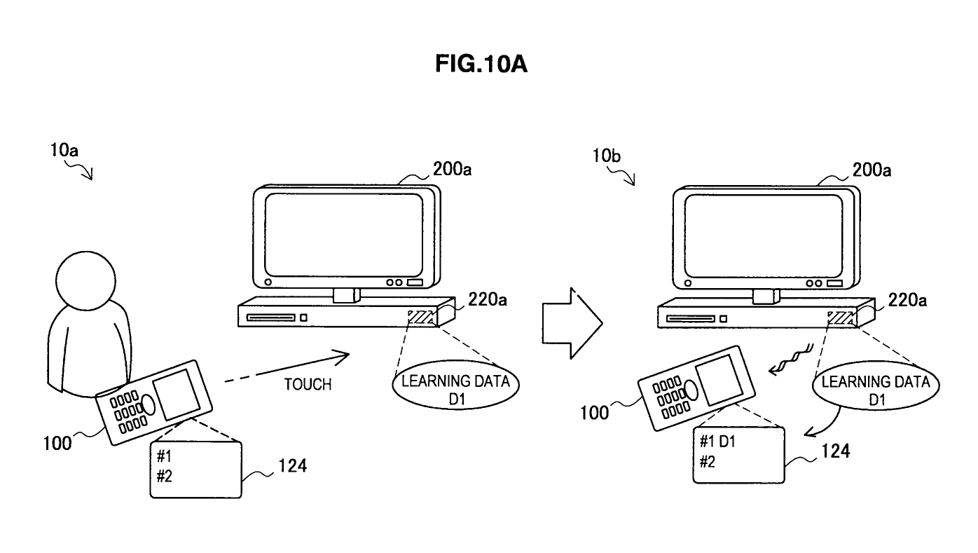

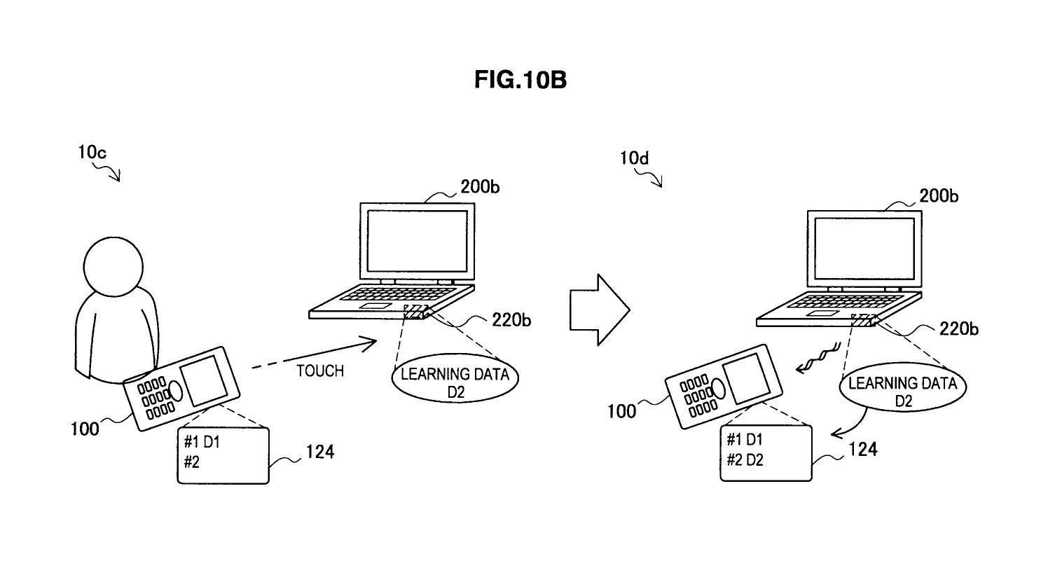

FIG. 10A and FIG. 10B are explanatory diagrams each showing the details of a view in which learning data of a plurality of apparatuses to be controlled are stored by the remote control device 100.

Referring to FIG. 10A, first, at a point before a user touches a communication device 200a with the remote control device 100, no data is stored in the learning memory 124 of the remote control device 100 (see 10a). Next, when the user has touched a near field radio communication tag 220a of the communication device 200a with the remote control device 100, learning data D1 that has been stored in advance in the near field radio communication tag 220a is transmitted to the remote control device 100. Then, the learning data D1 is stored in the address #1 of the learning memory 124 of the remote control device 100 (see 10b).

Next, in FIG. 10B, it is assumed that the user has touched a near field radio communication tag 220b of a communication device 200b with the remote control device 100 (see 10c). Then, learning data D2 that has been stored in advance in the near field radio communication tag 220b of the communication device 200b is stored in the address #2 of the learning memory 124 of the remote control device 100 (see 10d).

As described above, learning data related to control systems of a plurality of apparatuses to be controlled can be stored in the learning memory 124 of the remote control device 100. In such a case, it is preferable, for example, that the address of the learning memory 124 of the remote control device 100 be associated with the status of a specific user interface of the remote control device 100 (e.g., a switch position) when the apparatus to be controlled was touched with the remote control device 100. Accordingly, the user is able to call an adequate control system, which has been stored, by reproducing the status of the user interface (e.g., setting the switch position to the position at the time of the learning), for example, without touching the apparatus to be controlled again. Alternatively, the learning data can be called through a user operation performed via a screen provided on the remote control device 100 as described next.

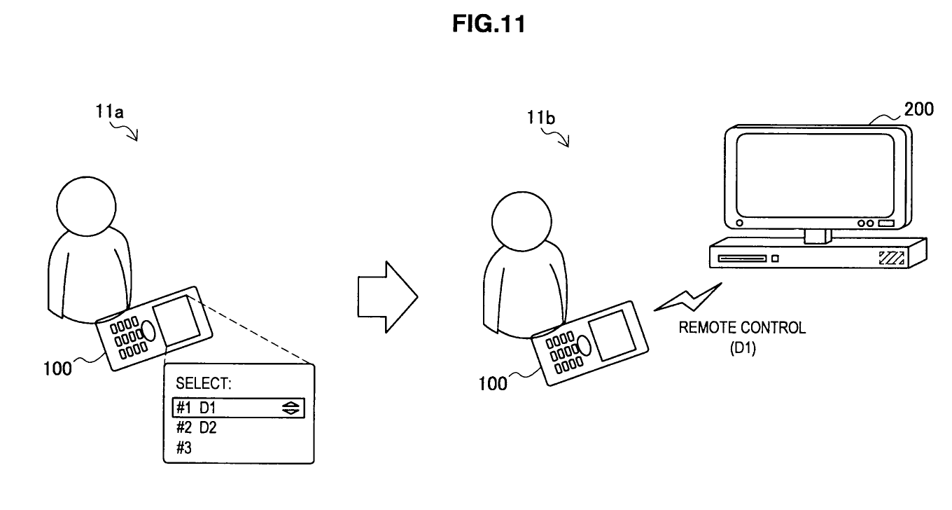

FIG. 11 is an explanatory diagram showing a view in which learning data selected from among a plurality of pieces of leaning data is used for remote control.

Referring to FIG. 11, first, two pieces of learning data D1 and D2, which have already been learned, are shown on the screen of the remote control device 100 (see 11a). The user, for example, selects either one of the learning data to be used for remote control by operating the screen. In the example of FIG. 11, the learning data D1 is selected. After selecting the learning data, by performing an operation for predetermined remote control, the user is able to remotely control the apparatus to be controlled using a communication method corresponding to the selected learning data (see FIG. 11b). Note that on the screen of the remote control device 100, not only the name, symbol, or the like attached to the learning data, but the name of a communication method identified from the learning data, the name of the apparatus to be controlled that has transmitted the learning data, or the like can be displayed.

According to such a configuration, it is possible to remotely control various apparatuses to be controlled using a single remote control device 100 while switching the communication method in accordance with the intention of the user without touching the apparatus to be controlled with the remote control device 100 each time the user attempts to remotely control the apparatus to be controlled. Further, as described next, the remote control device 100 can automatically switch the communication method used for remote control without a selection operation performed by the user.

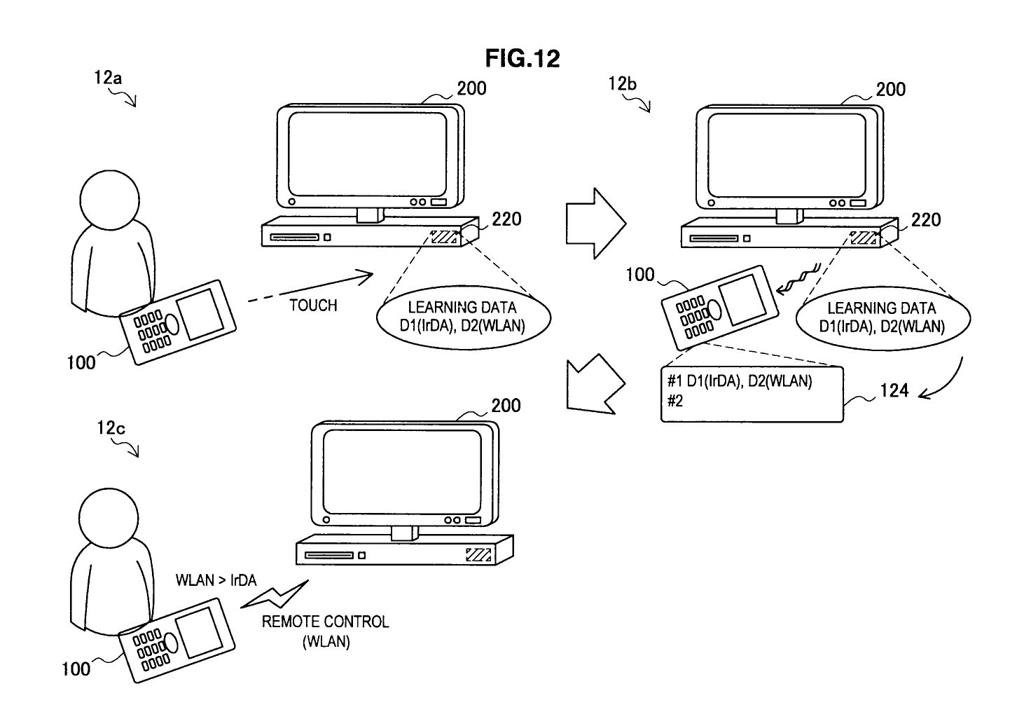

FIG. 12 is an explanatory diagram for illustrating automatic switching of the communication method when the apparatus to be controlled can perform control communication using a plurality of communication methods.

In the example of FIG. 12, it is assumed that the communication device 200 has two control communication units that respectively support IrDA and a wireless LAN, for example. Accordingly, in the near field radio communication tag 220 of the communication device 200, learning data D1 for the IrDA and learning data D2 for the wireless LAN (WLAN) are stored in advance (see 12a). Then, when the user has touched the near field radio communication tag 220 of the communication device 200 with the remote control device 100, the learning data D1 and D2 are transmitted from the near field radio communication tag 220 to the remote control device 100 (see 12b). Such learning data D1 and D2 are stored in the learning memory 124 of the remote control device 100.

Thereafter, when the user has operated the remote control device 100, the remote control unit 166 of the remote control device 100, for example, selects a communication method to be used for transmission of a control signal in accordance with a predetermined selection condition. The predetermined selection condition can be a condition that, for example, a communication method with a higher communication rate be preferentially used. For example, the communication rate of IrDA is several hundred kbps to several Mbps. Meanwhile, the communication rate of a wireless LAN that complies with a standard such as IEEE 802.11a, b, g, or n, for example, is several ten Mbps to several hundred Mbps. Herein, when the remote control device 100 and the communication device 200 can communicate with each other in accordance with IrDA and a wireless LAN, the remote control unit 166 can preferentially use the wireless LAN with a higher communication rate, for example. Alternatively, the predetermined selection condition can be a condition that, for example, a communication method with lower power consumption be preferentially used. As a further alternative, the predetermined selection condition can be a condition that, for example, in terms of the communication security, a communication method with higher communication confidentiality be preferentially used. Further, the predetermined selection condition can be a condition that, for example, a communication method with the minimum noise level at that point in time be preferentially used. Furthermore, a selection condition that is a combination of two or more of the aforementioned conditions can be used. Such selection conditions are stored in advance in the remote control device 100 in a form such that they can be changed by the user.

In the example of FIG. 12, the remote control unit 166 of the remote control device 100 selects a wireless LAN (e.g., IEEE 802.11g) with a higher communication rate than IrDA, and transmits a control signal to the communication device 200 via a control communication unit that supports the wireless LAN (see 12c).

According to such a configuration, when the remote control device 100 and the apparatus to be controlled can use control communication in accordance with a plurality of communication methods, the remote control device 100 can automatically select a communication method that is suited to control communication and transmit a control signal to the apparatus to be controlled. Accordingly, the user is able to remotely control the apparatus to be controlled through a simple operation without being aware of the communication method.

Heretofore, the first embodiment of the present invention has been described with reference to FIG. 1 to FIG. 12. According to this embodiment, it is possible to learn a control system for remotely controlling the apparatus to be controlled through a simple “touch” operation and to selectively use a control communication means. Accordingly, it is possible to widen the range of application of the remote control device 100 and to remotely control the apparatus to be controlled having a unique control system using the remote control device 100.

Note that the near field radio communication I/F 122 of the remote control device 100 can be a reader/writer provided in the remote control device 100 to perform charging for services other than the remote control, personal authentication, or the like. In that case, the remote control device 100 in accordance with one embodiment of the present invention described above can be constructed without requiring the cost for mounting additional hardware for performing only remote control.

### 2. Second Embodiment

In the communication device 200 in the first embodiment, the near field radio communication tag 220 is just provided on the main body of the device. Thus, the CPU 202 for controlling the main operation unit 270 and the near field radio communication tag 220 have never operated in a cooperative manner. In contrast, in the second embodiment of the present invention, an RF tag with input/output terminals is used as a near field radio communication tag so that the CPU in the main body of the apparatus to be controlled can be involved in the process of learning a control system for remote control.

[2-1. Exemplary Configuration of Remote Control Device]

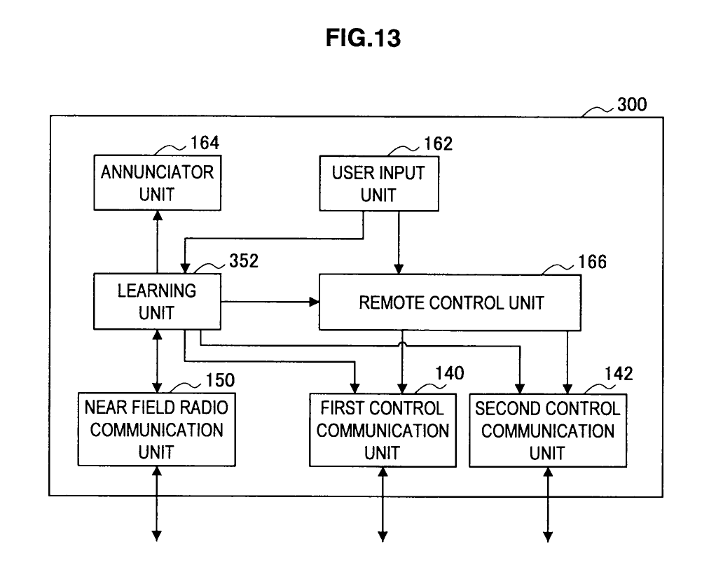

A remote control device 300 in accordance with this embodiment has about the same physical configuration as the remote control device 100 in accordance with the first embodiment. FIG. 13 is a block diagram showing an exemplary logical functional arrangement of the remote control device 300 in accordance with this embodiment. Referring to FIG. 13, the remote control device 100 includes a first control communication unit 140, a second control communication unit 142, a near field radio communication unit 150, a learning unit 352, a user input unit 162, an annunciator unit 164, and a remote control unit 166.

The learning unit 352 controls a process of learning a control system of an electronic apparatus (e.g., a communication device 400 described below) to be remotely controlled. The control system learning process of the learning unit 352 can be similar to the learning process of the learning unit 152 in accordance with the first embodiment described with reference to FIG. 5. However, the learning unit 352, if new learning data for remote control is received from the same apparatus from which learning data was received in the past, updates the learning data stored in the learning memory 124. In that case, the learning unit 253 can confirm with the user if the learning data should be updated via a display of the remote control device 300.

[2-2. Exemplary Configuration of Apparatus to be Controlled]

(Physical Configuration)

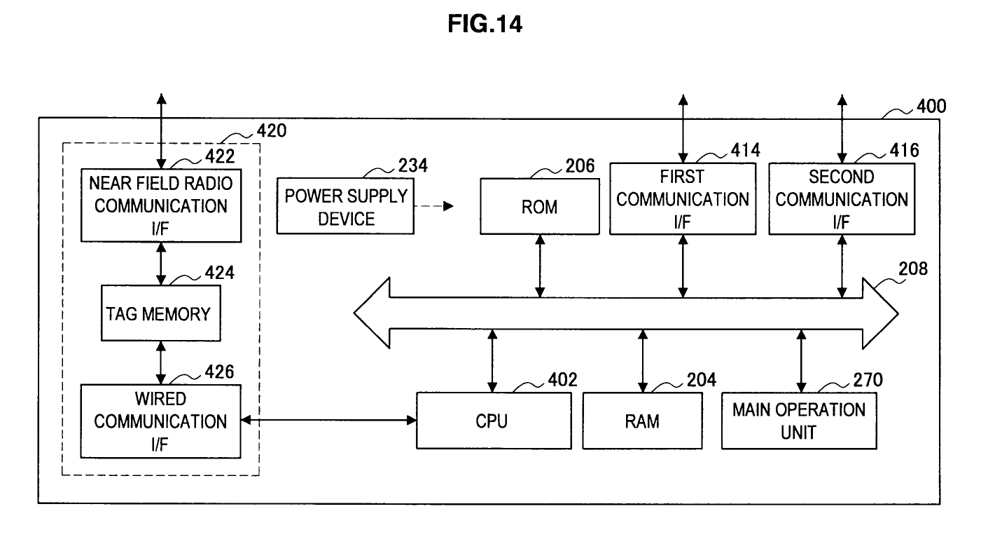

FIG. 14 is a block diagram showing an exemplary physical configuration of the communication device 400 that is the apparatus to be controlled in accordance with this embodiment. Referring to FIG. 14, the communication device 400 includes a CPU 402, RAM 204, ROM 206, a bus 208, a first communication I/F 414, a second communication I/F 416, a near field radio communication tag 420, a power supply device 234, and a main operation unit 270.

The CPU 402 is an arithmetic unit used to control the entire functions of the communication device 400. The CPU 402, for example, reads a control program stored in the ROM 206 and controls each unit of the communication device 400 in accordance with the program. In this embodiment, the CPU 402 also controls input/output of data stored in tag memory 424 of the near field radio communication tag 420.

Each of the first communication I/F 414 and the second communication I/F 416 is an interface that mediates communication between the communication device 400 and another device. In this embodiment, it is assumed that the first communication I/F 414 operates in accordance with Bluetooth®. It is also assumed that the second communication I/F 416 operates in accordance with IEEE 802.11g that is one of the standards of a wireless LAN.

The near field radio communication tag 420 is an RF tag including a near field radio communication I/F 422, the tag memory 424, and a wired communication I/F 426. The near field radio communication I/F 422 receives data from and outputs data to the tag memory 424 in response to a predetermined command transmitted from the remote control device 300. The tag memory 424 is a storage medium accessible from the near field radio communication I/F 422 and the wired communication I/F 426, and can be constructed as semiconductor memory such as flash memory, for example. The wired communication I/F 426 realizes access to the tag memory 424 from the CPU 402 in accordance with a wired communication method such as SPI (Serial Peripheral Interface) or 12C (Inter-Integrated Circuit).

(Logical Configuration)

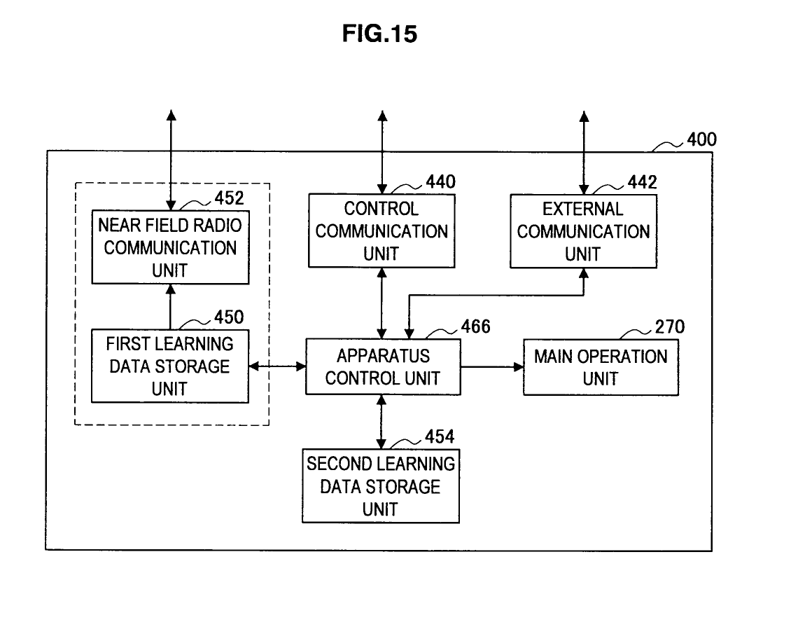

FIG. 15 is a block diagram showing an exemplary logical functional arrangement of the communication device 400 that is implemented using the physical configuration shown in FIG. 14. Referring to FIG. 15, the communication device 400 includes a control communication unit 440, an external communication unit 442, a first learning data storage unit 450, a near field radio communication unit 452, a second learning data storage unit 454, an apparatus control unit 466, and a main storage unit 270.

The control communication unit 440 receives a control signal transmitted from the remote control device 300, using the first communication I/F 414 shown in FIG. 14, for example. Then, the control communication unit 440 outputs the received control signal to the apparatus control unit 466.

The external communication unit 442 accesses an external network via a wireless LAN using the second communication I/F 416 shown in FIG. 14, for example. More specifically, the external communication unit 442 receives from another communication device firmware for newly using the second communication I/F 416 as a control communication means for remote control.

In the first learning data storage unit 450, learning data to be used for the remote control device 300 to remotely control the communication device 400 is stored in advance, using the tag memory 424 shown in FIG. 14. The learning data stored in the first learning data storage unit 450 can be rewritten by the apparatus control unit 466 described below. In addition, the first learning data storage unit 450 can also have stored therein partial data, which can be accommodated within the storage capacity of the tag memory 424, of large-size learning data. In that case, the remaining data can be stored in the second learning data storage unit 454 described below. Such learning data is read by the near field radio communication unit 452 in response to a request for transmission of learning data output from the near field radio communication unit 150 of the remote control device 300.

The near field radio communication unit 452 receives a signal output from the remote control device 300, using the near field radio communication I/F 422 shown in FIG. 14. More specifically, for example, the near field radio communication unit 452 receives a request for transmission of learning data from the remote control device 300. Then, the near field radio communication unit 452 reads the aforementioned learning data from the first learning data storage unit 450 in response to the received transmission request, and transmits the read learning data to the remote control device 300.

The apparatus control unit 466 controls the function of the main operation unit 270 of the communication device 400, using the CPU 402 shown in FIG. 14. In addition, in this embodiment, the apparatus control unit 466 rewrites the learning data stored in the first learning data storage unit 450 via the wired communication I/F 426 shown in FIG. 14.

For example, the apparatus control unit 466, when the data size of the learning data used for remote control of the communication device 400 exceeds the storage capacity of the first learning data storage unit 450, first stores a first portion, which is obtained by splitting the learning data into a plurality of portions, into the first learning data storage unit 450. Then, the apparatus control unit 466, upon confirming that the first portion has been transmitted to the remote control device 300 by the near field radio communication unit 452, stores the second portion following the first portion into the first learning data storage unit 450. In this manner, as the apparatus control unit 466 sequentially stores each data obtained by splitting the learning data into the first learning data storage unit 450, it is possible to allow the remote control device 300 to learn learning data with a large size that exceeds the storage capacity of the first learning data storage unit 450.

In addition, for example, the apparatus control unit 466 can store into the first learning data storage unit 450 learning data that is newer than the learning data currently stored in the first learning data storage unit 450. The new learning data can be, for example, data accompanying the addition or update of a control system for remotely controlling the communication device 400. In addition, the new learning data can include a new version of firmware (e.g., a version with added functions or a version with fixed bugs) for remotely controlling the communication device 400.

Suppose, for example, that an identifier, which can identify a communication method that can be used by the remote control device 300, is written to the first learning data storage unit 450 from the remote control device 300 via the near field radio communication unit 452. In that case, the apparatus control unit 466 can determine a communication method that can be used for control communication with the remote control device 300 on the basis of the identifier, and selectively store only the learning data that is related to the communication method, into the first learning data storage unit 450.

In addition, the apparatus control unit 466 can announce to the user the progress of the control system learning process that can be grasped on the basis of the content of data stored in the first learning data storage unit 450 or a success or failure of the attempt of control communication that is detected via the control communication unit 440. For example, when the communication device 400 is a receiver of a digital television broadcast, the control communication unit 440 can output the content of a message to be announced to the main operation unit 270 and display the message on the screen.

In the second learning data storage unit 454, the entirety of the learning data to be learned by the remote control device 300 is stored using the ROM 206 shown in FIG. 14, for example. Such learning data can be transferred to the first learning data storage unit 450 by, for example, being split or partially selected by the apparatus control unit 466 as described above.

Heretofore, exemplary configurations of the remote control device 300 and the communication device 400 in accordance with this embodiment have been described with reference to FIG. 13 to FIG. 15. Note that in this embodiment, the remote control device 300 and the communication device 400 can have more control communication units.

[2-3. Process Flow]

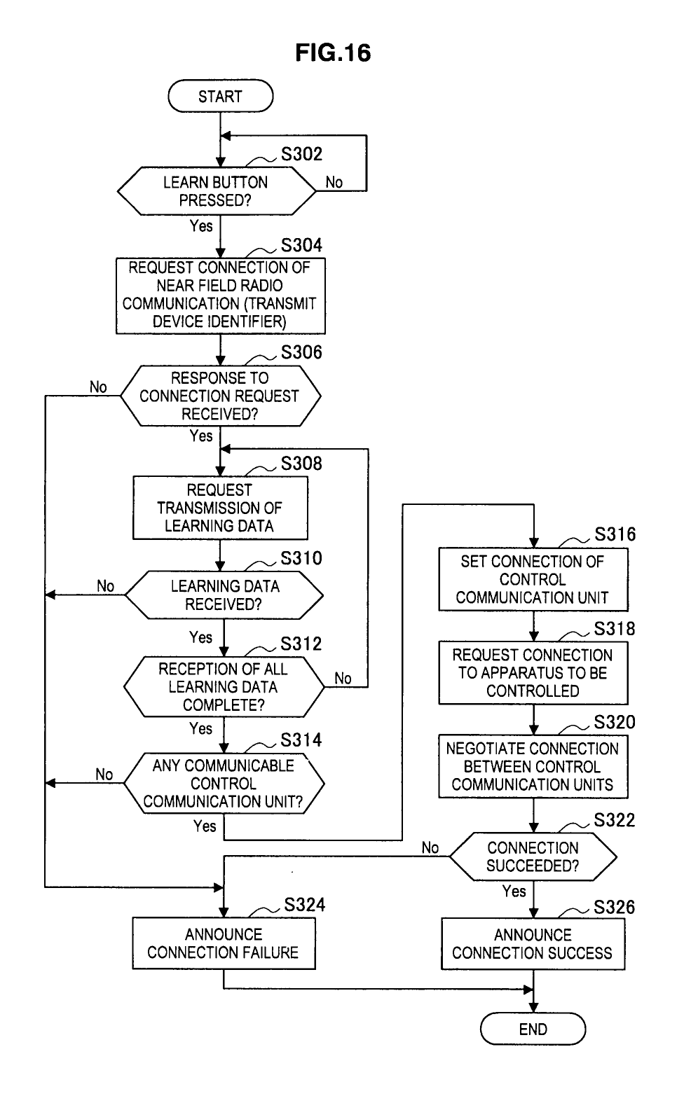

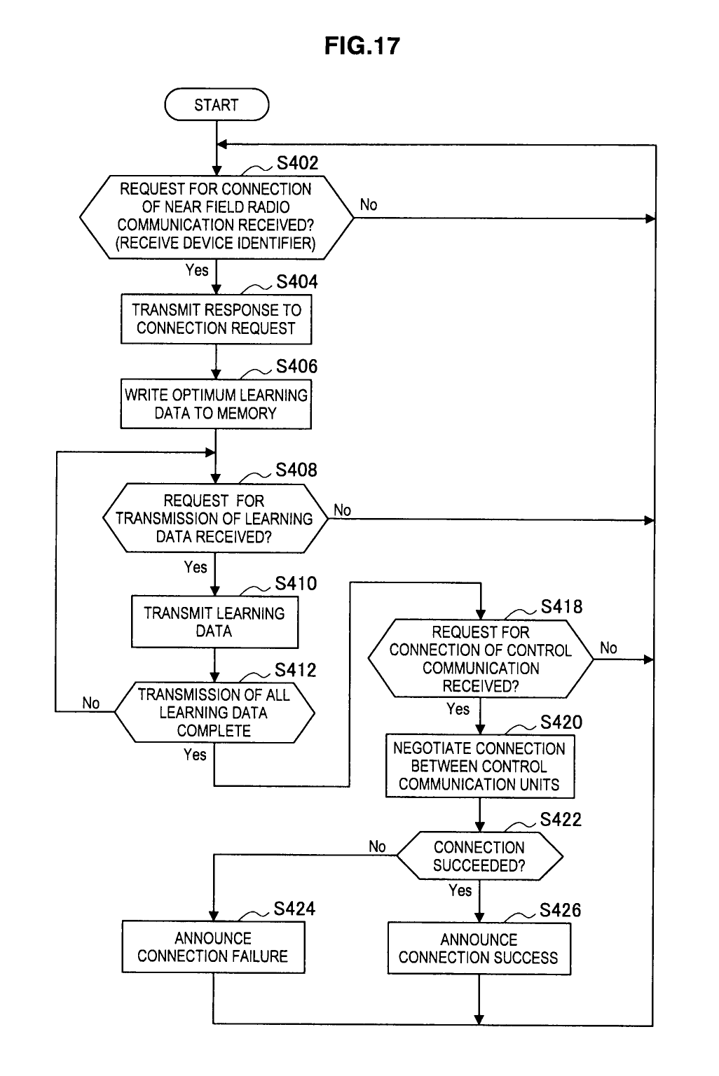

Next, a flow of a learning process up to the establishment of control communication between the aforementioned remote control device 300 and communication device 400 will be described with reference to FIG. 16 and FIG. 17. FIG. 16 is a flowchart showing an exemplary flow of a learning process of the remote control device 300 up to the establishment of control communication with the communication device 400.

Referring to FIG. 16, first, the user input unit 162 of the remote control device 300 determines if a learn button has been pressed (S302). Herein, if the learn button is determined to have been pressed, the learning unit 352 transmits a request for connection of near field radio communication to a nearby apparatus to be controlled via the near field radio communication unit 150 (S304). At this time, an identifier (e.g., a device identifier), which can identify a communication method that can be used by the remote control device 300, can be transmitted to the nearby apparatus to be controlled via the near field radio communication unit 150. Thereafter, the learning unit 352 waits for a response to the request for connection of near field radio communication (S306). Herein, if no response is received after a given time has elapsed, the connection fails upon time-out, and the process proceeds to step S324. Meanwhile, if a response to the request for connection of near field radio communication is received, the process proceeds to step S308.

In step S308, the learning unit 352 transmits a request for transmission of learning data to the communication device 400, which is the apparatus to be controlled having responded to the connection request, via the near field radio communication unit 150 (S308). Then, the learning unit 352 waits for the reception of learning data from the communication device 400 (S310). Herein, if learning data is not received after a given time has elapsed, the learning fails upon time-out, and the process proceeds to step S324. Meanwhile, if learning data is received from the communication device 400, the process proceeds to step S312.

In step S312, the learning unit 352 further determines if reception of all learning data is complete (S312). Herein, if reception of all learning data is complete, the process proceeds to step S312. Meanwhile, if reception of all learning data is not complete yet, the process returns to step S308, so that transmission and reception of the remaining learning data are repeated.

In step S314, the learning unit 352, on the basis of the received learning data, determines if there is any control communication unit that can communicate with the communication device 400 among the control communication units of the remote control device 300 (S314). Herein, if there is no control communication unit that can communicate with the communication device 400, the connection fails due to the mismatched functions, and the process proceeds to step S324. Meanwhile, if there is a control communication unit that can communicate with the communication device 400, the process proceeds to step S316.

Step S316 to step S320 are the steps making up the process performed by the learning unit 352 to attempt connection to the communication device 400.

First, in step S316, the learning unit 352, on the basis of the learning data received from the communication device 400, performs connection settings of the control communication unit to be used for remote control (S316). At this time, for example, if the received learning data includes new learning data corresponding to a communication method that has already been learned, the learning unit 352 updates the connection settings of the control communication unit set in the past. Next, the learning unit 352 requests a communication connection to the communication device 400, which is the apparatus to be controlled, via the set control communication unit (S318). Further, the learning unit 352 negotiates a connection with the communication device 400 as needed (S320).

Thereafter, in step S322, the learning unit 352 determines if the connection of control communication has succeeded (S322). Herein, if the connection of control communication has failed, the process proceeds to step S324. Meanwhile, if the connection of control communication has succeeded, the process proceeds to S326.

In step S324, the annunciator unit 164 announces the failure of the connection of control communication to the user using the annunciator device 132 (S324). Meanwhile, in step S326, the annunciator unit 164 announces the success of the connection of control communication to the user (S326). Note that in this embodiment, the communication device 400 can also announce a success or failure of the connection of control communication to the user as described below. Herein, if a success or failure of the connection of control communication is announced by the communication device 400, for example, the announcement process of the remote control device 300 can be omitted.

As a result of the aforementioned process, it becomes possible for the user to remotely control the communication device 400 using the remote control device 300.

FIG. 17 is a flowchart showing an exemplary flow of a response process performed by the communication device 400 in accordance with the learning process described with reference to FIG. 16.

Referring to FIG. 17, first, the near field radio communication unit 452 waits for the reception of a request for connection of near field radio communication from the remote control device 300 (S402). Then, upon receiving a request for connection of near field radio communication, the near field radio communication unit 452 transmits a response to the connection request to the remote control device 300 (S404). At this time, the near field radio communication unit 452 can further write the device identifier of the remote control device 300, which has been received together with the connection request, into the first learning data storage unit 450, and can also inform the apparatus control unit 466 that the connection request has been received, using a CPU interrupt signal or the like.

Next, the apparatus control unit 466, for example, acquires optimum learning data, which corresponds to the device identifier written in the first learning data storage unit 450, from among a plurality of pieces of learning data stored in the second learning data storage unit 454, and writes it to the first learning data storage unit 450 (S406). Note that the apparatus control unit 466 can, when passing not the learning data selected corresponding to the device identifier but all learning data to the remote control device 300, write the learning data to the first learning data storage unit 450 before receiving a connection request from the remote control device 300.

Next, the near field radio communication unit 452 waits for the reception of a request for transmission of learning data from the remote control device 300 (S408). Then, upon receiving a request for transmission of learning data, the near field radio communication unit 452 acquires learning data from the first learning data storage unit 450, and transmits the learning data to the remote control device 300 (S410). Thereafter, if transmission of all learning data is not complete yet, the process returns to step S408, so that transmission and reception of the remaining learning data are repeated (S412). At this time, the apparatus control unit 466 can monitor the status of transmission and reception of the learning data, and can, when transmission of a first portion of the split learning data is complete, for example, acquire a second portion following the first portion from the second learning data storage unit 454 and store it into the first learning data storage unit 450. Then, when transmission of all learning data is complete, the process proceeds to step S418.

In step S428, the apparatus control unit 466 waits for the reception of a request for connection of control communication from the remote control device 300 (S418). Herein, if a request for connection of control communication is not received after a given time has elapsed, the process returns to step S402. Meanwhile, if a request for connection of control communication is received, the apparatus control unit 466 negotiates a connection with the remote control device 300 via the communication control unit that has received the connection request (S420).

Thereafter, in step S422, the apparatus control unit 466 determines if the connection of control communication has succeeded (S422). Herein, if the connection of control communication has failed, the process proceeds to step S424. Meanwhile, if the connection of control communication has succeeded, the process proceeds to S426.

In step S424, the failure of the connection of control communication is announced to the user using a screen, a speaker, or the like of the main operation unit 270, for example (S424). Meanwhile, in step S426, the success of the connection of control communication is announced to the user using the screen, the speaker, or the like of the main operation unit 270, for example (S426).

Through a series of the aforementioned processes, it becomes possible to perform remote control using a communication method that can be used by the communication device 400 among a plurality of communication methods supported by the remote control device 300. In addition, even when the size of learning data for learning a control system for remote control exceeds the storage capacity of the tag memory 424 of the near field radio communication tag 420, it is possible to pass the large-size learning data by splitting the learning data and sequentially storing them into the tag memory 424. Further, this embodiment is advantageous in use scenes such as the one described in the next section.

[2-4. Examples of Use Scenes]

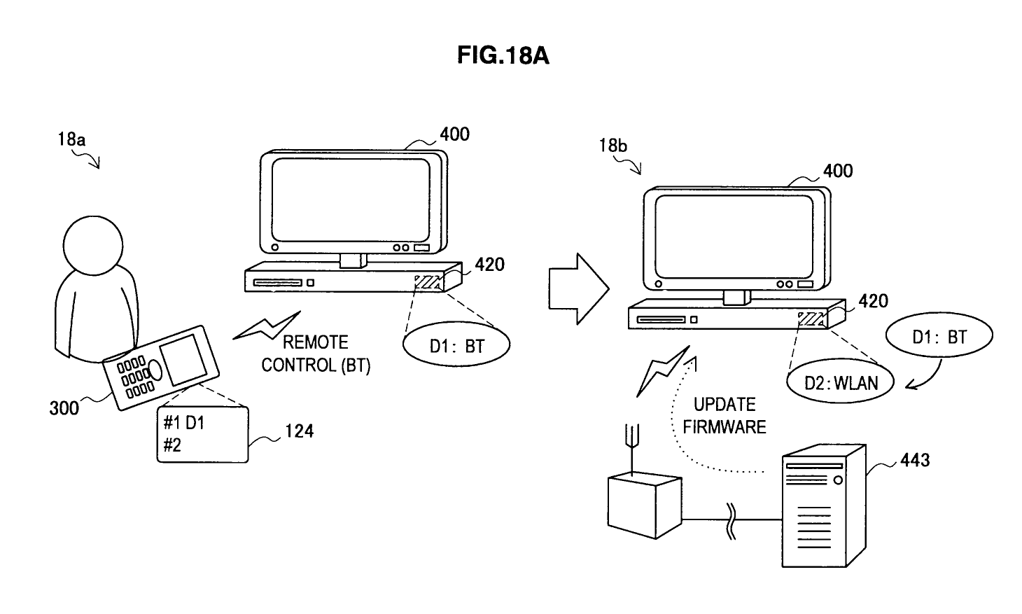

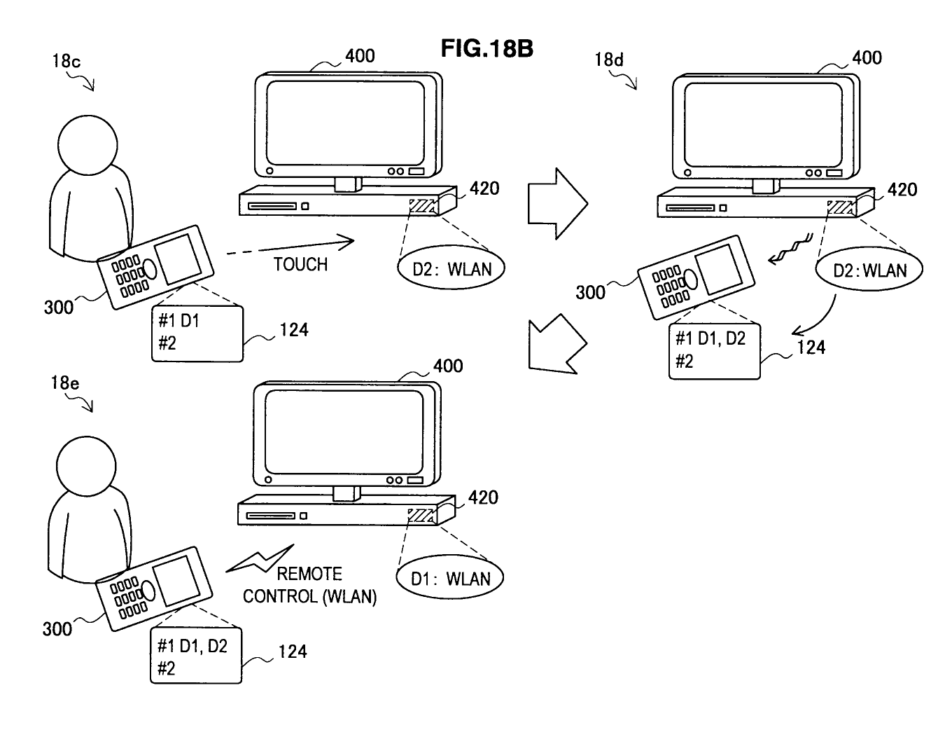

Hereinafter, scenes in which the remote control method in accordance with this embodiment is used will be described with reference to FIG. 18 to FIG. 20.

FIG. 18A and FIG. 18B are explanatory diagrams each showing a view in which a control system that has been once learned by the remote control device 300 is updated.

Referring to FIG. 18A, a user is remotely controlling the communication device 400 via Bluetooth® (abbreviated to BT in the drawing) corresponding to learning data D1, using the remote control device 300 having stored therein the learning data D1 learned in the past (see 18a). Thereafter, the communication device 400 receives from an external server 443 connected thereto via the external communication unit 442 new firmware for receiving remote control. Accordingly, it becomes possible for the communication device 400 to use a wireless LAN of IEEE 802.11g as a communication method for control communication. Then, the apparatus control unit 466 of the communication device 400 updates the learning data D1 stored in the first learning data storage unit 450 to learning data D2 corresponding to the wireless LAN of IEEE 802.11g (see 18b).

Next, referring to FIG. 18B, the user touches the near field radio communication tag 420 of the communication device 400 with the remote control device 300 while pressing a learn button of the remote control device 300, for example (see 18c). Then, the new learning data D2 stored in the radio communication tag 420 is transmitted from the near field radio communication tag 420 to the remote control device 300 (see 18d). The learning data D2 is then stored into (or added to) the learning memory 124 of the remote control device 300. Thereafter, when an attempt of control communication via a wireless LAN has succeeded, it becomes possible for the user to remotely control the communication device 400 via the wireless LAN with, for example, a higher communication rate than Bluetooth®, using the remote control device 300 (see 18e).

That is, according to the configuration in accordance with this embodiment, data stored in the first learning data storage unit 450 can be updated as needed in the communication device 400. Accordingly, it is possible to update a control system learned by the remote control device 300 at the same timing as the update of firmware in the apparatus to be controlled, only through a simple “touch” operation. Although the example shown herein is a case in which new firmware is received from the external server 443, the firmware in the communication device 400 can be updated via an externally connected storage medium, for example.

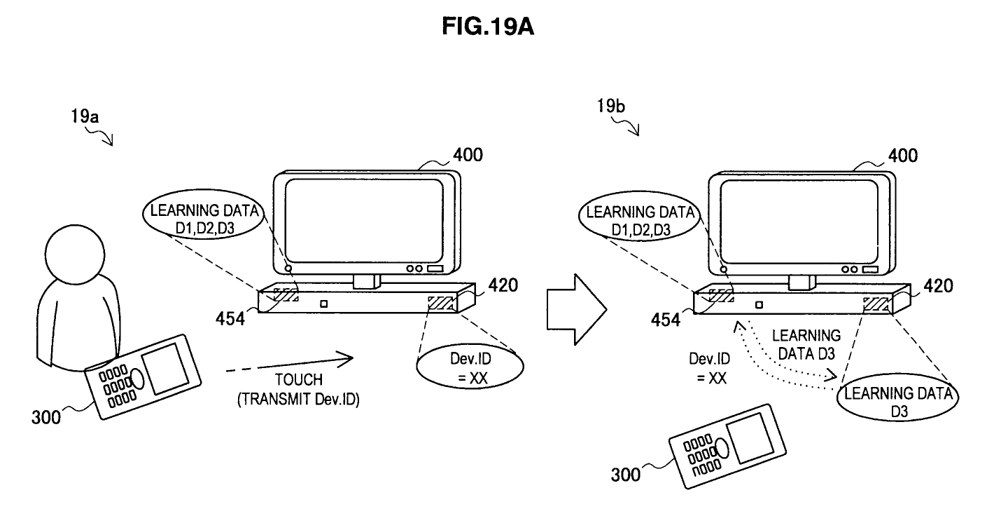

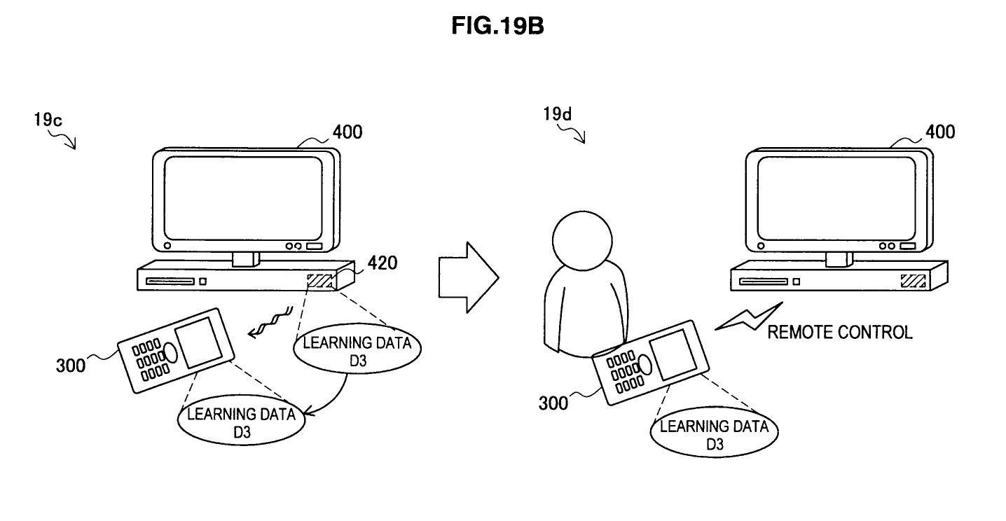

FIG. 19A and FIG. 19B are explanatory diagrams each showing a view in which learning data is selectively linked in accordance with a device identifier transmitted from the remote control device 300.

Referring to FIG. 19A, when a user has touched the near field radio communication tag 420 of the communication device 400 with the remote control device 300, a device identifier (abbreviated to Dev. ID in the drawing) is transmitted from the remote control device 300. Such a device identifier is received by the near field radio communication unit 452 of the communication device 400, and is then written to the first learning data storage unit 450 of the near field radio communication tag 420 (see 19a). Then, the apparatus control unit 466 of the communication device 400 acquires learning data corresponding to the device identifier from among a plurality of pieces of learning data stored in advance in the second learning data storage unit 454, and then writes it to the first learning data storage unit 450. In the example of FIG. 19A, learning data D3 is written in the first learning data storage unit 450 of the near field radio communication tag 420 among learning data D1, D2, and D3 stored in advance in the second learning data storage unit 454 (see 19b). Note that learning data corresponding to the device identifier can be, for example, learning data for using the same communication method as the communication method supported by a remote control device of a type represented by the device identifier. In addition, when there are a plurality of communication methods that are the same as the communication methods supported by the remote control device, learning data that is selected in accordance with a selection condition associated with the communication rate, power consumption, security, or noise level, for example, can be written to the first learning data storage unit 450.

Next, referring to FIG. 19B, the learning data D3 is transmitted from the near field radio communication tag 420 of the communication device 400 to the remote control device 300 (see 19c). The learning data D3 is then stored into the learning memory 124 of the remote control device 300. Note that a series of the processes from 19a to 19c is typically performed during a single touch operation. Thereafter, when an attempt of control communication between the remote control device 300 and the communication device 400 has succeeded, it becomes possible for the user to remotely control the communication device 400 using the remote control device 300 (see 19d).

According to such a configuration, when a plurality of pieces of learning data corresponding to a plurality of control systems is stored in advance in the communication device 400, for example, only a part of the learning data that is necessary for the remote control device 300 to perform remote control is transmitted and received. Accordingly, even when the total value of the size of the learning data prepared in advance in the communication device 400 is large, the remote control device 300 can efficiently learn a control system in a short time.

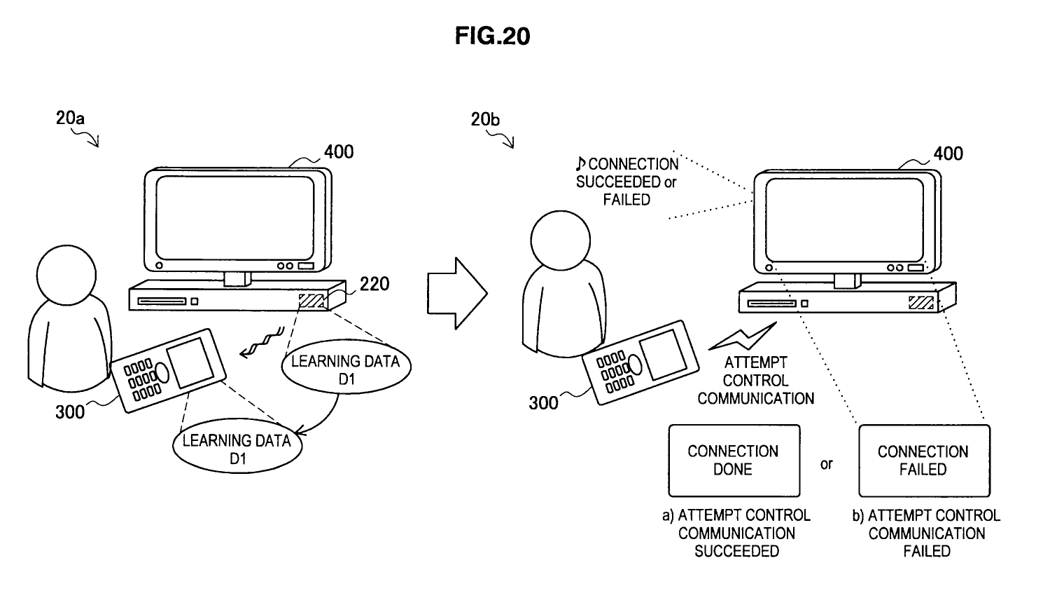

FIG. 20 is an explanatory diagram showing a view in which the result of an attempt of control communication between the remote control device 300 and the communication device 400 is announced by the communication device 400.

Referring to FIG. 20, after learning data D1 is transmitted from the near field radio communication tag 420 of the communication device 400 to the remote control device 300 (see 20a), connection of control communication is attempted between the remote control device 300 and the communication device 400. Then, if the connection of control communication between the remote control device 300 and the communication device 400 has succeeded or failed is announced to the user using a screen and sound of the main operation unit 270 of the communication device 400 (see 20b).

According to such a configuration, even when the remote control device 300 does not have an annunciator device, the user is able to easily know if remote control of the communication device 400 has become possible after he/she has touched the communication device 400 with the remote control device 400.

Heretofore, the second embodiment of the present invention has been described with reference to FIG. 13 to FIG. 20. According to this embodiment, content in the memory for storing learning data can be dynamically updated in the communication device 400, which is the apparatus to be controlled, as described above. Accordingly, a learning process of the remote control device 300 can be performed efficiently, or large-size learning data can be used for learning a control system regardless of the storage capacity of the memory.

[2-5. Another Exemplary Configuration of Apparatus to be Controlled]

In this embodiment, an example in which an RF tag with input/output terminals is used for the communication device 400 has been described. In contrast, when the apparatus to be controlled has a reader/writer capable of operating in a card emulation mode of near field radio communication, such a reader/writer can be used instead of the RF tag. The “card emulation mode” refers to an operation mode in which a reader/writer behaves as if it is an RF tag. For example, a reader/writer that complies with the NFC standard can operate in the card emulation mode, and can receive a command such as data input/output from another reader/writer by behaving as if it is an RF tag.

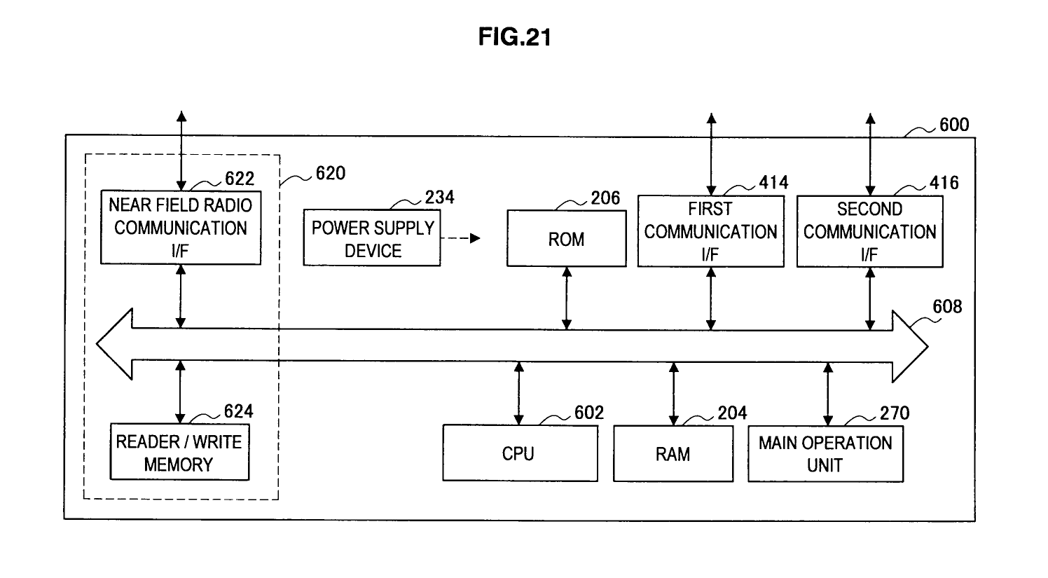

FIG. 21 is a block diagram showing an exemplary physical configuration of a communication device 600 having a reader/writer that operates in the card emulation mode. Referring to FIG. 21, the communication device 600 includes a CPU 602, RAM 204, ROM 206, a bus 608, a first communication I/F 414, a second communication I/F 416, a near field radio communication I/F 622, reader/writer memory 624, a power supply device 234, and a main operation unit 270.

The CPU 602 is an arithmetic device used to control the entire functions of the communication device 600. The CPU 602, for example, reads a control program stored in the ROM 206 and controls each unit of the communication device 600 in accordance with the program. In this embodiment, the CPU 602 also controls near field radio communication with a remote control device using the near field radio communication I/F 622.

The bus 608 mutually connects the CPU 202, the RAM 204, the ROM 206, the first communication I/F 414, the second communication I/F 416, the near field radio communication I/F 622, the reader/writer memory 624, and the main operation unit 270.

The near field radio communication I/F 622 and the reader/writer memory 624 constitute a reader/writer 620 that is capable of communicating with an RF tag in accordance with a near field radio communication method. The reader/writer 620 operates in the card emulation mode. That is, the reader/writer 620 behaves as if it is a similar RF tag to the near field radio communication tag 420 of the communication device 400 shown in FIG. 14.

The communication device 600 with the aforementioned configuration can be an electronic apparatus that has a reader/writer of an RF tag (or an IC card) for purposes of, for example, charging, settlement, or authentication, such as an Internet TV. In such a case, as the reader/writer usually has memory with a higher storage capacity than RF tags, learning data with a larger data amount can be efficiently transmitted and received in comparison with the aforementioned communication device 400.

Meanwhile, when the apparatus to be controlled does not have a specific near field radio communication means, it is possible to connect an external reader/writer that is operable in the card operation mode to the apparatus to be controlled so that communication with the remote control device 300 is realized as the communication device 400 does.

For example, suppose a stationary game machine that can use Bluetooth® as a communication method for control communication, has an USB port for connection to a peripheral device, and can communicate with an external server via a network. In such a case, a user, for example, externally attaches a reader/writer that complies with NFC to the game machine via the USB port. Accordingly, it becomes possible for the game machine to transmit learning data corresponding to new firmware, which has been received from the external server, to the remote control device 300 using the card emulation mode of the reader/writer. Accordingly, a control system corresponding to the new firmware in the game machine can be used for remotely controlling the game machine only through a simple touch operation.

[2-6. Another Form of Communication Between Remote Control Device and Apparatus to be Controlled]

When the apparatus to be controlled has a reader/writer with a near field radio communication method, mutual communication between reader/writer can be used between the reader/writer of the apparatus to be controlled and the near field radio communication unit 150 of the remote control device 300 (see FIG. 13), for example.

For example, a reader/writer that complies with the NFC standard or Felica® standard has a mutual communication function between reader/writer. When such a mutual communication function between reader/writer is used, the CPU of the remote control device 300 and the CPU of the apparatus to be controlled can directly transfer data to each other. Thus, the efficiency of the control system learning process can be further increased.

Further, in this case, it is also possible to use a near field radio communication reader/writer that combines a high-speed communication method such as Transfer JET in addition to the near field radio communication method (e.g., NFC) used for a settlement process or the like. In such a case, learning data with a large size that exceeds several mega bytes, such as an application program to operate on the remote control device, can be transferred to the remote control device in a short time.

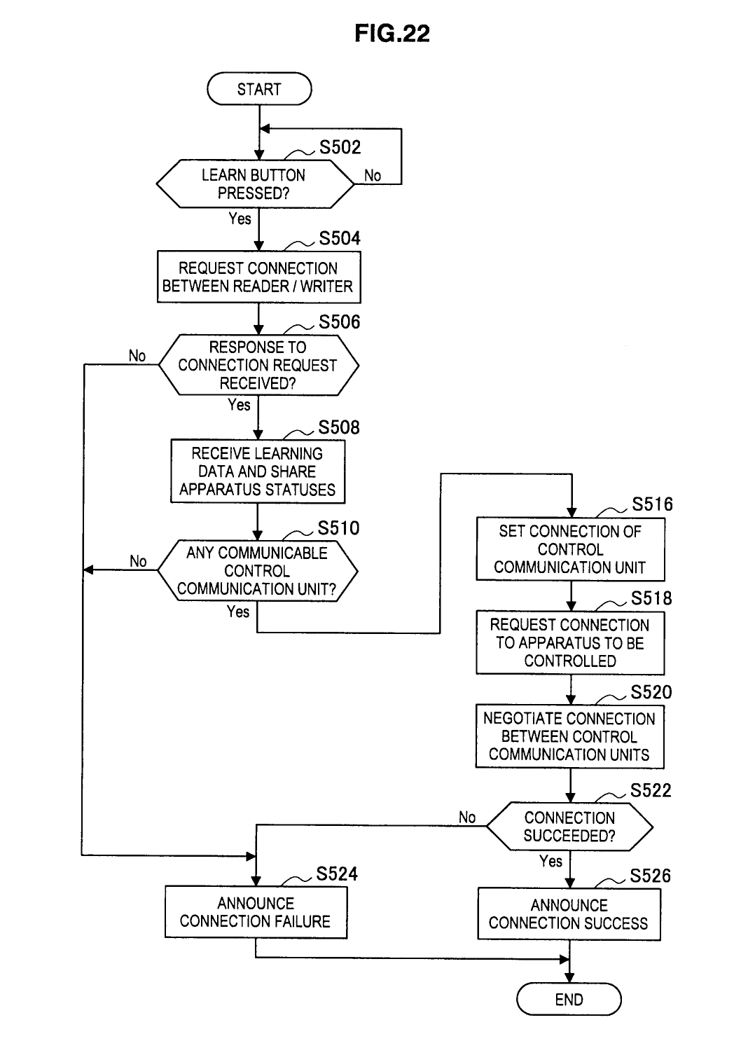

FIG. 22 is a flowchart showing an exemplary flow of a learning process of the remote control device 300 up to the establishment of control communication when a control system is learned with the use of a high-speed communication method such as Transfer JET between the remote control device 300 and the communication device 600.

Referring to FIG. 22, first, the user input unit 162 of the remote control device 300 determines if a learn button has been pressed (S502). Herein, if the learn button is determined to have been pressed, the learning unit 352 transmits a request for connection between reader/writer to a nearby apparatus to be controlled via the near field radio communication unit 150 (S504). Thereafter, the learning unit 352 waits for a response to the request for connection between reader/writer (S506). Herein, if no response is received after a given time has elapsed, the connection fails upon time-out, and the process proceeds to step S524. Meanwhile, if a response to the request for connection of near field radio communication is received, the process proceeds to step S508.

In step S508, learning data transmitted from the communication device 600, which is the apparatus to be controlled having responded to the connection request, is received through high-speed communication between reader/writer via the near field radio communication unit 150 (S508). At this time, the apparatus status of each of the remote control device 300 and the communication device 600 is shared. Next, the learning unit 352, on the basis of the received learning data, determines if there is any communication method that allows communication between the remote control device 300 and the communication device 600 (S510). Herein, if there is no communication method that allows communication, the connection fails due to the mismatched functions, and the process proceeds to step S524. Meanwhile, if there is a communication method that allows communication, the process proceeds to step S516.

In step S516, the learning unit 352, on the basis of the learning data received from the communication device 600, performs connection settings of the control communication unit to be used for remote control (S516). Next, the learning unit 352 requests a communication connection to the communication device 600, which is the apparatus to be controlled, via the set control communication unit (S518). Further, the learning unit 352 negotiates a connection with the communication device 600 as needed (S520).

Thereafter, in step S522, the learning unit 352 determines if the connection of control communication has succeeded (S522). Herein, if the connection of control communication has failed, the process proceeds to step S524. Meanwhile, if the connection of control communication has succeeded, the process proceeds to S526.

In step S524, the annunciator unit 164 announces the failure of the connection of control communication to the user using the annunciator device 132 (S524). In step S526, the annunciator unit 164 announces the success of the connection of control communication to the user (S526). Note that when a success or failure of the connection of control communication is announced by the communication device 600, for example, the annunciation process of the remote control device 300 can be omitted.

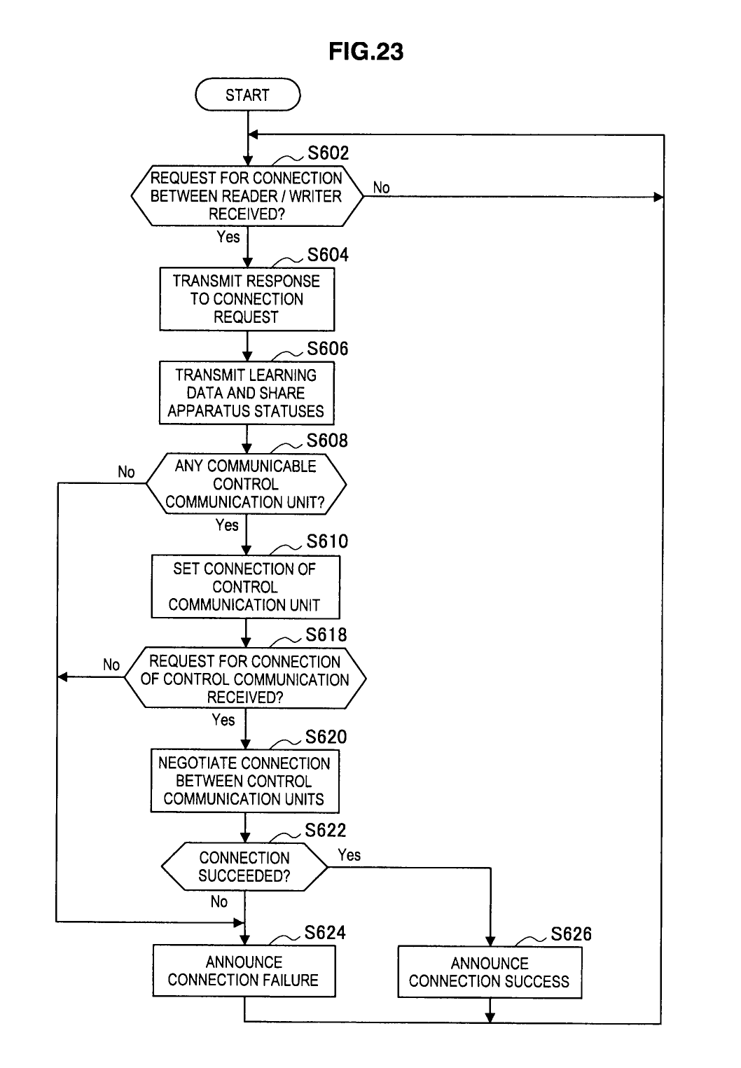

FIG. 23 is a flowchart showing an exemplary flow of a response process performed by the communication device 600 in accordance with the learning process described with reference to FIG. 22.

Referring to FIG. 23, first, the apparatus control unit 466 of the communication device 600 waits for the reception of a connection request from the remote control device 300 (S602). Then, upon receiving a request for connection between reader/writer from the remote control device 300, the apparatus control unit 466 transmits a response to the connection request to the remote control device 300 (S604). Then, the apparatus control unit 466 acquires learning data from the first learning data storage unit 450, and transmits the learning data to the remote control device 300 in accordance with a high-speed communication method between reader/writer (S606). At this time, the apparatus status of each of the remote control device 300 and the communication device 600 is shared. Next, the apparatus control unit 466, in accordance with the shared apparatus statuses, determines if there is any communication method that allows communication between the remote control device 300 and the communication device 600 (S608). Herein, if there is no communication method that allows communication, the connection fails due to the mismatched functions, and the process proceeds to step S624. Meanwhile, if there is a communication method that allows communication, the process proceeds to step S610.

In step S610, the apparatus control unit 466, on the basis of the apparatus statuses shared with the remote control device 300, performs connection settings of the control communication unit to be used for remote control (S610). Next, the apparatus control unit 466 waits for the reception of a connection request from the remote control device 300 via the set control communication unit (S618). Herein, if no connection request is received after a given time has elapsed, the connection fails upon time-out, and the process proceeds to step S624. Meanwhile, if a connection request is received, the process proceeds to step S620. Next, in step S620, the apparatus control unit 466 negotiates a connection with the remote control device 300 (S620).

Thereafter, in step S622, the apparatus control unit 466 determines if the connection of control communication has succeeded (S622). Herein, if the connection of control communication has failed, the process proceeds to step S624. Meanwhile, if the connection of control communication has succeeded, the process proceeds to S626. In step S624, the failure of the connection of control communication is announced to the user using a screen, a speaker, or the like of the main operation unit 270, for example (S624). Meanwhile, in step S626, the success of the connection of control communication is announced to the user using the screen, the speaker, or the like of the main operation unit 270, for example (S626).

Through a series of the aforementioned processes, the remote control device 300 can efficiently learn a control system for remotely controlling the communication device 600 using a high-speed communication method between reader/writer.

### 3. Third Embodiment

In the aforementioned first and second embodiments, learning data associated with a control system for remotely controlling the apparatus to be controlled is typically stored in memory that is provided in advance in the apparatus to be controlled. However, there can also exist apparatuses to be controlled that do not have memory with a sufficient storage capacity, like a cheap edition of a portable music player or a wirelessly controllable toy, for example. Thus, this section will describe the third embodiment of the present invention in which a control system of the apparatus to be controlled, which does not have memory with a sufficient storage capacity, can be easily learned.

[3-1. Exemplary Configuration of Remote Control Device]

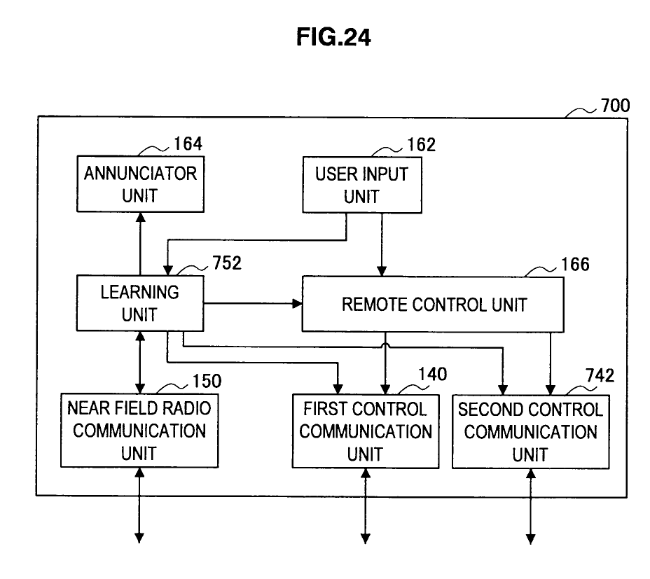

FIG. 24 is a block diagram showing an exemplary logical functional arrangement of a remote control device 700 in accordance with this embodiment. Referring to FIG. 24, the remote control device 700 includes a first control communication unit 140, a second control communication unit 742, a near field radio communication unit 150, a learning unit 752, a user input unit 162, an annunciator unit 164, and a remote control unit 166.

The second control communication unit 740 can be used to remotely control the apparatus to be controlled with the remote control unit 166. In addition, the second control communication unit 740 communicates with an external server, which holds learning data for remotely controlling the apparatus to be controlled, via another communication device that can communicate with the external server.

The learning unit 752 controls a process of learning a control system of the apparatus to be controlled. More specifically, the learning unit 752 receives a learning data reference code, which is a code capable of identifying learning data to be acquired, including the manufacturer, model name, serial number, or the like of the apparatus to be controlled, via the near field radio communication unit 150. Next, the learning unit 752, on the basis of the received learning data reference code, receives learning data for learning a control system of the apparatus to be controlled from an external server with which the learning unit 752 can communicate via the aforementioned second control communication unit 742 and another communication device. Then, the learning unit 752 stores the received learning data into a storage medium.

Heretofore, an example in which the second communication control unit 742 communicates with an external server via another communication device has been described. Such another communication device can be one of the apparatuses to be controlled that can be remotely controlled using the remote control device 700. Alternatively, when the remote control device 700 has a communication means that can be directly connected to an external network (e.g., when the remote control device 700 is a portable phone terminal), the second control communication unit 740 can communicate with an external server without via another communication device.

[3-2. Exemplary Configuration of Apparatus to be Controlled]

(Logical Configuration)

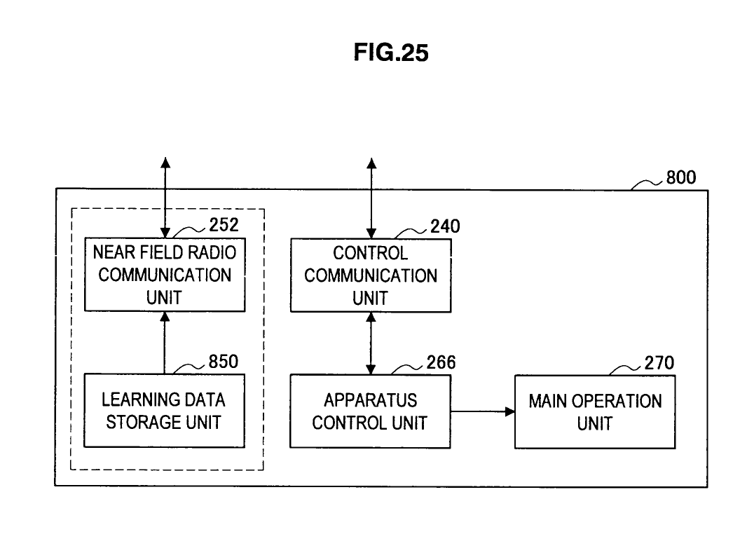

FIG. 25 is a block diagram showing an exemplary logical functional arrangement of a communication device 800 that is the apparatus to be controlled in accordance with this embodiment. Referring to FIG. 25, the communication device 800 includes a control communication unit 240, a learning data storage unit 850, a near field radio communication unit 252, an apparatus control unit 266, and a main operation unit 270.

In the learning data storage unit 850, a learning data reference code, which can identify learning data to be used for the remote control device 700 to remotely control the communication device 800, is stored in advance, using memory of a near field radio communication tag. Such learning data reference code is read in response to a data transmission request output from the near filed radio communication unit 150 of the remote control device 700, and is then transmitted to the remote control device 700.

[3-3. Examples of Use Scenes]

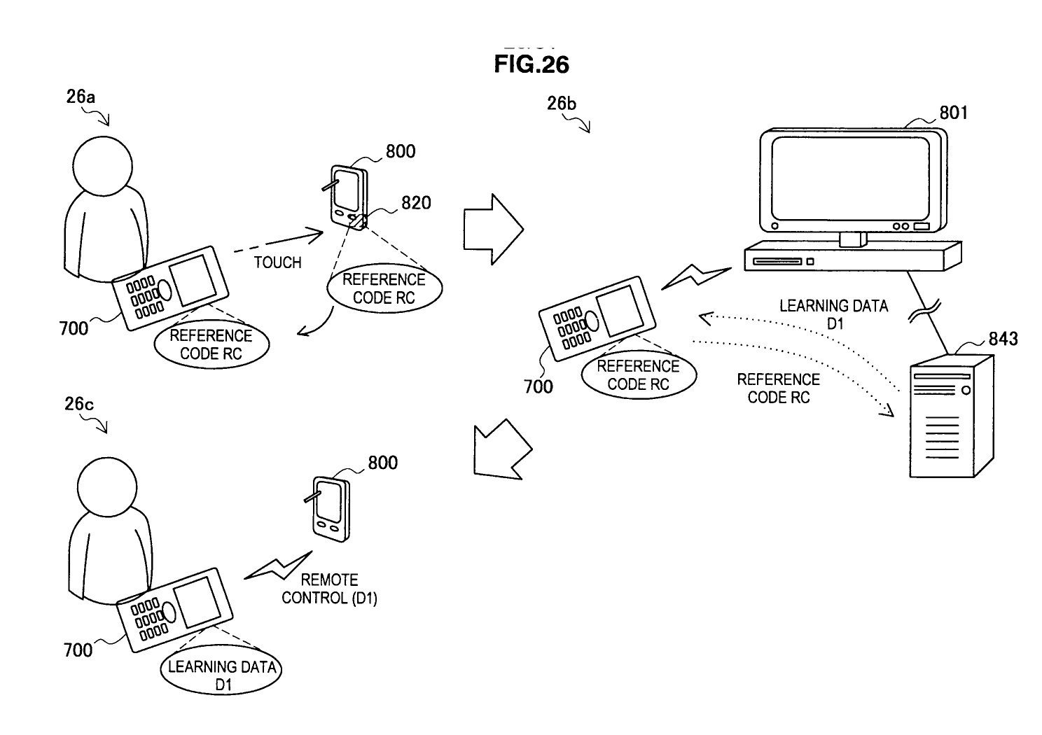

FIG. 26 is an explanatory diagram showing a view in which remote control of the communication device 800 is started using the remote control device 700. Note that described herein is an example in which the communication device 800, which is the apparatus to be controlled, is a portable music player.

Referring to FIG. 26, first, a user touches a near field radio communication tag 820 of the communication device 800 with the remote control device 700 while pressing a learn button of the remote control device 700. Then, a learning data reference code RC, which has been stored in advance in the near field radio communication tag 820, is transmitted from the near field radio communication tag 820 to the remote control device 700 (see 26a). Such learning data reference code RC is stored into the learning memory 124 of the remote control device 700.

Next, the learning unit 752 of the remote control device 700 communicates with an external sever 843 via the second control communication unit 742 and a communication device 801, and receives learning data D1 corresponding to the learning data reference code RC (see 26b). Then, if an attempt of control communication corresponding to the learning data D1 has succeeded, it becomes possible for the user to remotely control the communication device 800 using the remote control device 700 (see 26c).

According to such a configuration, the remote control device 700 can learn a control system of the apparatus to be controlled without being subject to the restrictions on the memory storage capacity of an RF tag in the apparatus to be controlled. For example, the remote control device 700 can download from the aforementioned external server 843 an application for performing high-level control that is specific to the apparatus to be controlled. Further, for example, the remote control device 700 can receive from the external server 843 firmware for the apparatus to be controlled to receive remote control, and can transmit the received firmware to the apparatus to be controlled via either one of the control communication units or the near field radio communication unit 150. Accordingly, the apparatus to be controlled can update the firmware for receiving remote control even if the apparatus to be controlled does not have a communication means for communicating with the external server 843.

Heretofore, the third embodiment of the present invention has been described with reference to FIG. 24 to FIG. 26. According to this embodiment, learning data for learning a control system of the apparatus to be controlled, which does not have memory with a sufficient storage capacity, is acquired from an external server on the basis of a learning data reference code received from a near field radio communication tag provided on the apparatus to be controlled. Accordingly, a control system of the apparatus to be controlled can be learned without being subject to the restrictions on the memory storage capacity of the near field radio communication tag of the apparatus to be controlled.

### 4. Variation

Conventionally available AV apparatuses, household electrical apparatuses like so-called major appliances, and the like are typically not provided with a near field radio communication means in many cases. Examples of such apparatuses include cathode-ray tube television receivers and heating and air-conditioning apparatuses. Thus, this section will describe a method for handling such an apparatus without a near field radio communication means as the apparatus to be controlled in accordance with the aforementioned first embodiment.

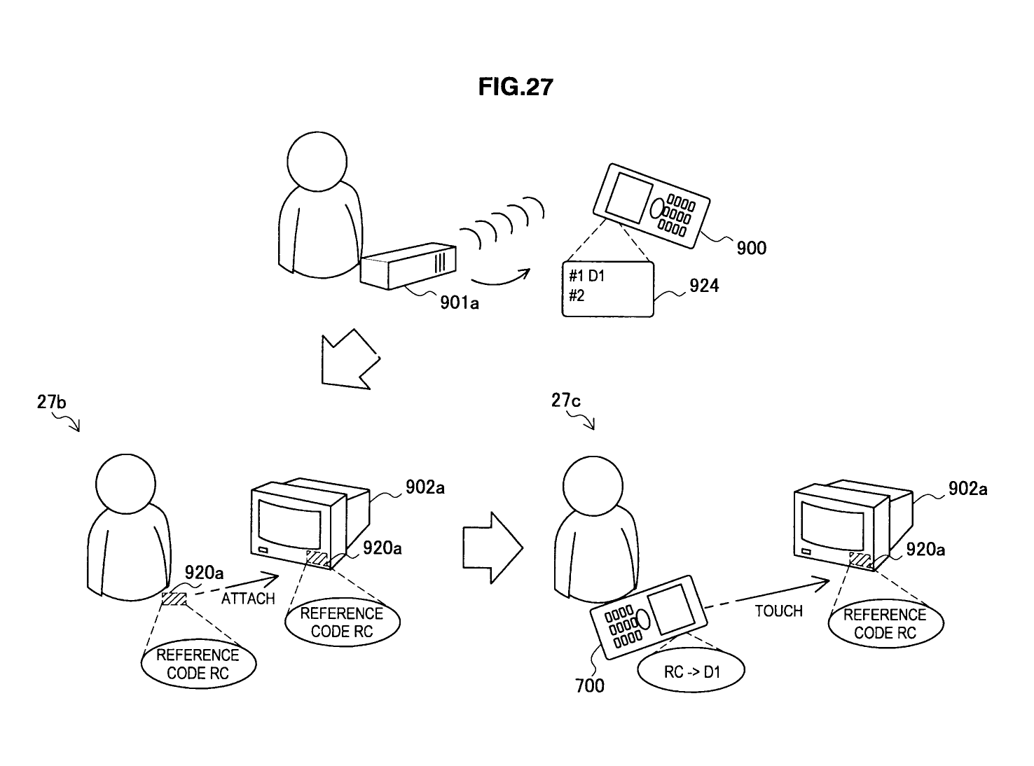

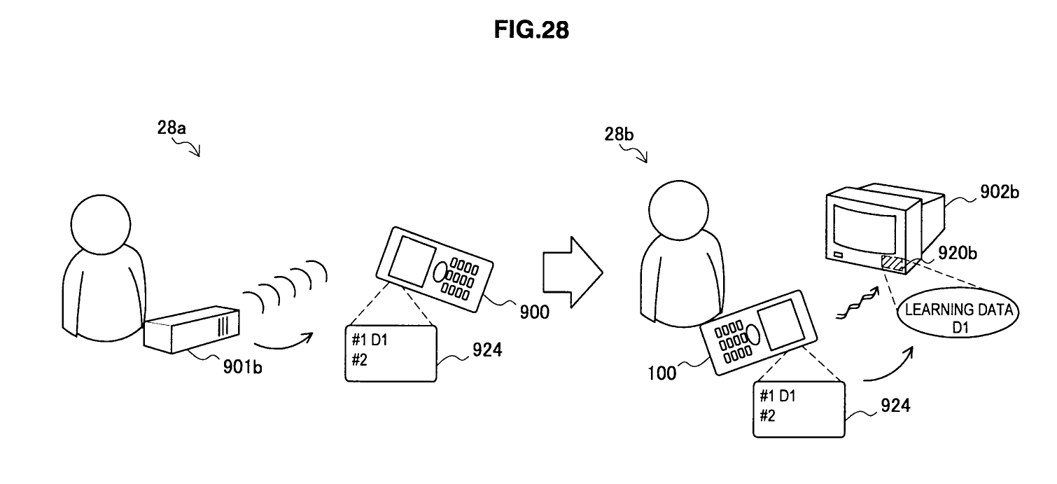

FIG. 27 and FIG. 28 are explanatory diagrams for illustrating a method of providing learning data to an apparatus 902a to be controlled or an apparatus 902b to be controlled, each of which does not have a near field radio communication means.

Referring to FIG. 27, first, a user informs a remote control device 900 in accordance with the present variation of a control system of the apparatus 902a to be controlled from a special remote control device 901a of the apparatus 902a to be controlled, using infrared communication or the like. Then, the control system of the apparatus to be controlled is stored as learning data D1 in the address #1 of learning memory 924 of the remote control device 900 (see 27a). Next, the user attaches a near field radio communication tag 920a having stored therein a learning data reference code RC, for example, to the surface of the apparatus 920a to be controlled (see 27b). Then, when the near field radio communication tag 920a of the apparatus 902a to be controlled is touched with the remote control device 900, the aforementioned learning data D1 is associated with the learning data reference code RC in the remote control device 900 (see 27c). Accordingly, it becomes possible for the user to remotely control the apparatus 902a to be controlled using the remote control device 900 only by touching the near field radio communication tag 920a of the apparatus 902a to be controlled with the remote control device 900.

Meanwhile, referring to FIG. 28, first, a user informs the remote control device 900 of a control system of the apparatus 902b to be controlled from a special remote control device 901b of the apparatus 902b to be controlled, using infrared communication or the like (see 28a). Then, when a near field radio communication tag 920b attached to the surface of the apparatus 902b to be controlled is touched with the remote control device 900, for example, learning data D1 is written to the near field radio communication tag 920b by the remote control device 900 (see 28b). In this case also, it becomes possible for the user to remotely control the apparatus 902b to be controlled using the remote control device 900 only by touching the near field radio communication tag 920b of the apparatus 902b to be controlled with the remote control device 900.

### 5. Conclusion

Heretofore, the first to third embodiments and a variation of the present invention have been described with reference to FIG. 1 to FIG. 28. According to each embodiment, a user is able to cause a remote control device to learn a control system for remotely controlling the apparatus to be controlled only through a simple “touch” operation and to selectively use a control communication means. In addition, when a tag that can be connected to a CPU of the apparatus to be controlled is used as a near field radio communication tag of the apparatus to be controlled, the control system, which has been learned by the remote control device, can be updated in accordance with an update or the like of the firmware in the apparatus to be controlled without the user having to perform complex operations.

In addition, a manufacturer of a remote control device that applies each embodiment can reduce the cost for supporting remote control of various apparatuses to be controlled by, for example, releasing the development environments of firmware and applications, which are related to the establishment of control communication, to the public or by selling them through licensing. This is because, the work for verifying the operation of remote control of the apparatuses to be controlled and the work for standardizing control systems can be eliminated. Further, manufacturers of remote control devices can also check the operation by creating learning data only for the apparatuses to be controlled to which a connection is particularly desired to be attempted, such as their own apparatuses of the manufacturers, and can entrust a connection to other apparatuses to manufacturers of those apparatuses. Meanwhile, manufacturers of the apparatuses to be controlled can check the operation by creating learning data only for remote control devices to which a connection is particularly desired to be attempted, such as portable phone terminals, portable game machines, or the like having a high share. Thus, it becomes easier to keep a balance of the cost and merits between the manufacturers of remote control devices and the manufacturers of the apparatus to be controlled.

Although the preferred embodiments of the present invention have been described in detail with reference to the appended drawings, the present invention is not limited thereto. It is obvious to those skilled in the art that various modifications or variations are possible insofar as they are within the technical scope of the appended claims or the equivalents thereof. It should be understood that such modifications or variations are also within the technical scope of the present invention.

### REFERENCE SIGNS LIST

100, 300, 700, 900 Remote control device
140, 142, 742 Control communication unit (of the remote control device)
150 Near field radio communication unit (of the remote control device)
152, 352, 752 Learning unit
162 User input unit
164 Annunciator unit
166 Remote control unit
200, 400, 600, 800 Communication device (apparatus to be controlled)
220, 420 Near field radio communication tag
620 Reader/writer
240 Control communication unit (of the apparatus to be controlled)
250, 450, 850 (First) learning data storage unit
252, 452 Near field radio communication unit (of the apparatus to be controlled)
454 (Second) learning data storage unit
266, 466 Apparatus control unit
270 Main operation unit

1. A remote control device comprising:
a near field radio communication unit capable of performing communication in accordance with a near field radio communication method;
two or more control communication units each capable of performing communication in accordance with a communication method having a wider communication range than the near field radio communication method;
a learning unit that receives learning data to be used for remotely controlling an apparatus to be controlled via the near field radio communication unit, and stores the received learning data into a storage medium; and
a remote control unit that transmits a control signal for remotely controlling the apparatus to be controlled via one of the two or more control communication units on the basis of the learning data stored in the storage medium.

2. The remote control device according to claim 1, wherein the learning data includes data that identifies one or more communication methods that can be used by the apparatus to be controlled.

3. The remote control device according to claim 2, wherein the remote control unit, when two or more communication methods are identified from the learning data, selects a communication method to be used for transmission of the control signal from among the two or more communication methods in accordance with a predetermined selection condition.

4. The remote control device according to claim 3, wherein the predetermined selection condition is a condition associated with at least one of a communication rate, power consumption, security, and a noise level.

5. The remote control device according to claim 1, further comprising a user input unit that allows a user to, when two or more pieces of the learning data are stored in the storage medium, select one of the two or more pieces of the learning data, wherein the remote control unit transmits the control signal via a control communication unit corresponding to the learning data selected by the user via the user input unit.

6. The remote control device according to claim 1, wherein the learning unit, after receiving the learning data via the near field radio communication unit, attempts communication with the apparatus to be controlled via one of the two or more control communication units on the basis of the learning data.

7. The remote control device according to claim 6, further comprising an annunciator unit that announces to a user a result of the attempt of the learning unit to communicate with the apparatus to be controlled.

8. A communication device comprising:
a near field radio communication unit capable of performing communication in accordance with a near field radio communication method;
a storage unit in which learning data to be used for remotely controlling the communication device is stored using a storage medium accessible from the near field radio communication unit; and
a control communication unit capable of receiving a control signal for receiving remote control from a remote control device in accordance with a communication method having a wider communication range than the near field radio communication method,
wherein the learning data includes data that identifies at least a communication method that can be used by the control communication unit.

9. The communication device according to claim 8, further comprising:
an external communication unit capable of communicating with another communication device; and
a control unit that receives new firmware to be used for remotely controlling the communication device via the external communication unit, and stores new learning data corresponding to the received firmware into the storage unit.

10. The communication device according to claim 8, further comprising a control unit that, when a data size of the learning data exceeds a storage capacity of the storage unit, splits the learning data into a plurality of pieces of data and sequentially stores each split data into the storage unit.

11. The communication device according to claim 8, further comprising a control unit that stores one of a plurality of pieces of leaning data that can be used for remotely controlling the communication device into the storage unit in accordance with an identifier of a remote control device written to the storage unit.

12. The communication device according to claim 8, wherein the near field radio communication unit is a reader/writer capable of behaving as a near field radio communication tag in accordance with the near field radio communication method.

13. A remote control method using a remote control device, the remote control device including a near field radio communication unit capable of performing communication in accordance with a near field radio communication method, and two or more control communication units each capable of performing communication in accordance with a communication method having a wider communication range than the near field radio communication method, the method comprising the steps of:
receiving learning data to be used for remotely controlling an apparatus to be controlled from the apparatus to be controlled via the near field radio communication unit;
storing the received learning data into a storage medium; and
transmitting a control signal for remotely controlling the apparatus to be controlled via one of the two or more control communication units on the basis of the learning data stored in the storage medium.

14. A program for causing a computer that controls a remote control device including a near field radio communication unit capable of performing communication in accordance with a near field radio communication method, and two or more control communication units each capable of performing communication in accordance with a communication method having a wider communication range than the near field radio communication method, to function as:
a learning unit that receives learning data to be used for remotely controlling an apparatus to be controlled via the near field radio communication unit, and stores the received learning data into a storage medium; and
a remote control unit that transmits a control signal for remotely controlling the apparatus to be controlled via one of the two or more control communication units on the basis of the learning data stored in the storage medium.
